(19) United States
(12) Patent Application Publication
(10) Pub. No.: US 2023/0199757 A1
(43) Pub. Date: Jun. 22, 2023

(54) USE OF MULTIPLE CONFIGURED GRANTS FOR VARIABLE PACKET SIZES OR VARIABLE RELIABILITY REQUIREMENTS FOR WIRELESS NETWORKS

(71) Applicant: NOKIA TECHNOLOGIES OY, Espoo (FI)

(72) Inventors: Vinh VAN PHAN, Oulu (FI); Ling YU, Kauniainen (FI); Zexian LI, Espoo (FI)

(21) Appl. No.: 17/996,186

(22) PCT Filed: Apr. 15, 2020
(86) PCT No.: PCT/EP2020/060575

§ 371 Date: Oct. 13, 2022

(51) Int. Cl. H04W 72/1268; H04W 72/54; H04W 72/23

(52) U.S. Cl. CPC H04W 72/1268; H04W 72/23; H04W 72/54

(57) ABSTRACT

According to an example embodiment, an apparatus includes at least one processor; and at least one memory including computer program code; the at least one memory and the computer program code configured to, with the at least one processor, cause the apparatus at least to: receive, by a user device, a configuration associated with a first configured grant that is allocated to the user device and an indication of availability of resources associated with at least one second configured grant; and define, by the user device based on an amount of data to be transmitted, a latency requirement and/or a reliability requirement, that a transmission is to be performed by the user device using both the configuration associated with the first configured grant and at least part of the resources associated with the at least one second configured grant, and perform the transmission accordingly.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP’s Long Term Evolution (LTE) upgrade path for mobile networks. In LTE, base stations or access points (APs), which are referred to as enhanced Node B (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G & 4G wireless networks. 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an aspect, a method may include receiving, by a user device, a configuration associated with a first configured grant that is allocated to the user device and an indication of availability of resources associated with at least one second configured grant; and defining, by the user device based on an amount of data to be transmitted, a latency requirement and/or a reliability requirement, that a transmission is to be performed by the user device using both the configuration associated with the first configured grant and at least part of the resources associated with the at least one second configured grant, and performing the transmission accordingly.

According to an aspect, an apparatus may include means for receiving, by a user device, a configuration associated with a first configured grant that is allocated to the user device and an indication of availability of resources associated with at least one second configured grant; means for defining, by the user device based on an amount of data to be transmitted, a latency requirement and/or a reliability requirement, that a transmission is to be performed by the user device using both the configuration associated with the first configured grant and at least part of the resources associated with the at least one second configured grant, and means for performing the transmission accordingly.

According to an aspect, a computer program may comprise instructions which, when the program is executed by a computer, cause the computer to carry out: receiving, by a user device, a configuration associated with a first configured grant that is allocated to the user device and an indication of availability of resources associated with at least one second configured grant; and defining, by the user device based on an amount of data to be transmitted, a latency requirement and/or a reliability requirement, that a transmission is to be performed by the user device using both the configuration associated with the first configured grant and at least part of the resources associated with the at least one second configured grant, and performing the transmission accordingly.

According to an aspect, an apparatus may include at least one processor; and at least one memory including computer program code; the at least one memory and the computer program code configured to, with the at least one processor, cause the apparatus at least to: receive, by a user device, a configuration associated with a first configured grant that is allocated to the user device and an indication of availability of resources associated with at least one second configured grant; and define, by the user device based on an amount of data to be transmitted, a latency requirement and/or a reliability requirement, that a transmission is to be performed by the user device using both the configuration associated with the first configured grant and at least part of the resources associated with the at least one second configured grant, and perform the transmission accordingly.

According to an aspect, a method may include transmitting, by a network node, a configuration associated with a first configured grant that is allocated to a user device and an indication of availability of resources associated with at least one second configured grant, wherein the at least one second configured grant is associated with the first configured grant; receiving, by the network node, when the user device is transmitting via at least part of the resources associated with the at least one second configured grant, an indication that the user device is transmitting data according to the at least one second configured grant; receiving, by the network node from the user device, as an uplink data transmission, data according to at least the first configured grant and, when indicated by the user device, also according to the at least one second configured grant; and when acting as a primary cell node, combining data related to the uplink data transmission; or when acting as a secondary cell node, transmitting data related to the uplink data transmission to the primary cell node.

According to an aspect, an apparatus may include means for transmitting, by a network node, a configuration associated with a first configured grant that is allocated to a user device and an indication of availability of resources associated with at least one second configured grant, wherein the at least one second configured grant is associated with the first configured grant; means for receiving, by the network node, when the user device is transmitting via at least part of the resources associated with the at least one second configured grant, an indication that the user device is transmitting data according to the at least one second configured grant; means for receiving, by the network node from the user device, as an uplink data transmission, data according to at least the first configured grant and, when indicated by the user device, also according to the at least one second configured grant; and when acting as a primary cell node, means for combining data related to the uplink data transmission; or when acting as a secondary cell node, means for transmitting data related to the uplink data transmission to the primary cell node.

According to an aspect, a computer program may comprise instructions which, when the program is executed by a computer, cause the computer to carry out: transmitting, by a network node, a configuration associated with a first configured grant that is allocated to a user device and an indication of availability of resources associated with at least one second configured grant, wherein the at least one second configured grant is associated with the first configured grant; receiving, by the network node, when the user device is transmitting via at least part of the resources associated with the at least one second configured grant, an indication that the user device is transmitting data according to the at least one second configured grant; receiving, by the network node from the user device, as an uplink data transmission, data according to at least the first configured grant and, when indicated by the user device, also according to the at least one second configured grant; and when acting as a primary cell node, combining data related to the uplink data transmission; or when acting as a secondary cell node, transmitting data related to the uplink data transmission to the primary cell node.

According to an aspect, an apparatus may include at least one processor; and at least one memory including computer program code; the at least one memory and the computer program code configured to, with the at least one processor, cause the apparatus at least to: transmit, by a network node, a configuration associated with a first configured grant that is allocated to a user device and an indication of availability of resources associated with at least one second configured grant, wherein the at least one second configured grant is associated with the first configured grant; receive, by the network node, when the user device is transmitting via at least part of the resources associated with the at least one second configured grant, an indication that the user device is transmitting data according to the at least one second configured grant; receive, by the network node from the user device, as an uplink data transmission, data according to at least the first configured grant and, when indicated by the user device, also according to the at least one second configured grant; and when acting as a primary cell node, combine data related to the uplink data transmission; or when acting as a secondary cell node, transmit data related to the uplink data transmission to the primary cell node.

Other example embodiments are provided or described for various described example methods, including: means for performing any of the example methods; a non-transitory computer-readable storage medium comprising instructions stored thereon that, when executed by at least one processor, are configured to cause a computing system to perform any of the example methods; and an apparatus including at least one processor, and at least one memory including computer program code, the at least one memory and the computer program code configured to, with the at least one processor, cause the apparatus at least to perform any of the example methods.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a flow chart illustrating operation of a user device (UE) according to an example embodiment.

FIG. 3 is a diagram illustrating an allocation of configured grants according to an example embodiment.

FIG. 4 is a flow chart illustrating operation of a system according to an example embodiment.

FIG. 5 is a flow chart illustrating operation of a network node according to an example embodiment.

FIG. 6 is a block diagram of a wireless station, network node or wireless node (e.g., AP, BS, RAN node, UE or user device, or other wireless node or network node) according to an example embodiment.

### DETAILED DESCRIPTION

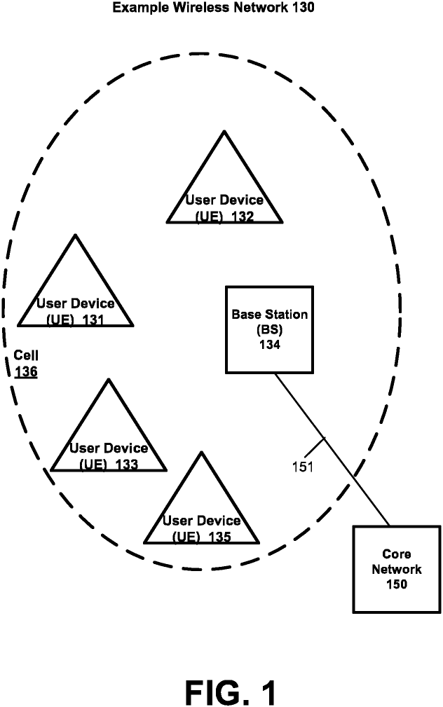

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a BS, next generation Node B (gNB), a next generation enhanced Node B (ng-eNB), or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS). At least part of the functionalities of a BS (e.g., access point (AP), base station (BS) or (e)Node B (eNB), BS, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface or NG interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a centralized unit (CU) and/or a distributed unit (DU) in the case of a split BS or split gNB), or other network node.

According to an illustrative example, a BS node (e.g., BS, eNB, gNB, CU/DU, ...) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, ...) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node (e.g., BS, eNB, gNB, CU/DU, ...) may forward data to the UE that is received from a network or the core network, and/or forward data received from the UE to the network or core network. RAN nodes (e.g., BS, eNB, gNB, CU/DU, ...) may perform a wide variety of other wireless functions or services, e.g., such as broadcasting control information (e.g., such as system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform. A base station may also be DU (Distributed Unit) part of IAB (Integrated Access and Backhaul) node (a.k.a. a relay node). DU facilitates the access link connection(s) for an IAB node.

A user device (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. A user device may be also MT (Mobile Termination) part of IAB (Integrated Access and Backhaul) node (a.k.a. a relay node). MT facilitates the backhaul connection for an IAB node.

In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network.

In addition, by way of illustrative example, the various example embodiments or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR) -related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The various example embodiments may be applied to a wide variety of wireless technologies or wireless networks, such as LTE, LTE-A, 5G (New Radio (NR)), cmWave, and/or mmWave band networks, IoT, MTC, eMTC, eMBB, URLLC, NR sidelink communications, etc., or any other wireless network or wireless technology. These example networks, technologies or data service types are provided only as illustrative examples.

Dynamic scheduling may allow a scheduler (e.g., provided at a network node or BS/gNB) to frequently (e.g., each transmission time interval (TTI) or subframe) grant or allocate resources to a user device (or UE) for an uplink transmission or a downlink reception. Thus, for example, dynamic scheduling may allow a UE to receive grants every subframe or TTI. Each grant may be provided by a BS/gNB or network node to a UE in response to a request. Grants based on dynamic scheduling may be referred to as dynamic grants.

However, some services may require more frequent or periodic transmission or reception of data. Using a dynamic scheduling for these type of services or applications, for example, may create significant signaling overhead. In an example embodiment, a semi-persistent scheduling (SPS) may also be used in which a BS (or network node) may provide a configured grant for periodic resources for the UE. With configured grant (CG), or grant-free, scheduling, the BS or network node reserves resources for uplink transmission for the CG, and informs the UE(s) of the reserved resources. When a UE initiates a transmission via the CG, the UE uses the reserved resources of the CG without sending a scheduling request and waiting for a grant message from the network node or BS. In an illustrative example, for an uplink transmission, a configured grant type 1 or type 2 may be used for a configured grant, by way of illustrative example embodiments.

For a configured grant type 1, an uplink grant is provided or communicated via radio resource control (RRC) signaling/message, including activation of the grant. In type 1 configured grant, by way of illustrative example, the transmission parameters of the configured grant, e.g., which may include periodicity, time offset, frequency resources (e.g., the time offset and the frequency resources may comprise the time-frequency resources of the configured grant), and modulation and coding scheme (MCS) for uplink transmissions, may be configured via RRC signaling. For example, upon receiving the RRC configuration of the configured grant, if there is data in the UE transmit buffer, the UE may start to use the configured grant for uplink transmission in the time instant indicated by the periodicity and the offset.

For a configured grant type 2, RRC signaling may be used to configure the periodicity (or period) of the configured grant, while one or more other transmission parameters (e.g., frequency resources and/or MCS) of the configured grant may be provided or configured as part of the activation of the configured grant via layer ⅟layer 2 (L1/L2) signaling, such as via downlink control information (DCI) and/or physical downlink control channel (PDCCH). For example, upon receiving the activation command via PDCCH, the UE may transmit according to the configured grant if there is data in the buffer for transmission. For both type 1 and type 2 configured grants, if there is no data in the buffer of the UE for transmission, then the UE does not transmit via the configured grant.

SPS based configured grant (CG) (which may simply be referred to as configured grant (CG)), such as UL CG, may be used to provide resources for some types of applications or services, such as URLLC (as an illustrative example), e.g., which may avoid the latency of UL packet access by the UE via dynamic grant, e.g., including the scheduling latency in the per-transmission dynamic resource allocation (for dynamic grant) from the serving network node/BS (including requesting latency from the UE). However, SPS based UL CG is not flexible and efficient enough for service flows with variable packet sizes and/or instantaneous data rates that may vary, i.e., the data amount (which may vary) to be transmitted may need to be transmitted within a preconfigured latency requirement (e.g., within a maximum packet delay budget, maximum packet delay or other time period) which may be denoted as Tp. The UL CG may need to be dimensioned or configured for the maximum packet size or data amount, which may be denoted as Lm, that needs to be transmitted within (or per) Tp. This may lead to significant resource consumption for URLLC support (and/or wasting of resources, in some cases), especially considering also that data duplication may need to be performed for URLLC support using multi-carrier and/or multi-connectivity transmissions. Thus, CGs typically cannot flexibly accommodate (or scale for) different packet sizes or different transmission amounts.

For some service flows, such as for some type of URLLC service flows, e.g., for extreme real-time interactive services, such as for augmented reality/virtual reality (AR/VR), for example, there may be more than one coordinated or synchronized service flows and therefore, there may be a need to transmit more than one packet of different service flows within the same Tp interval (latency requirement).

Also, for some type of service flows, such as for (e.g., URLLC) service flows for providing operation safety for an industrial automation system, for example, there may be a need to send regular or periodic packets from the UE with a strict requirement on consecutive packet errors. That is, the controller for the operation safety of the industrial automation system may (or may have a need to) receive, for example, a preconfigured number of (e.g., one) packets of the corresponding service flow from the user device in every, preconfigured number (e.g., three) of consecutive packets of the corresponding service flow sent by the user device. Otherwise, the controller considers that the user device is down and out of the operation (or non-operational). This may result in shutting down the industrial automation system. Therefore, from the serving network perspective, the reliability requirement on individual packets of the corresponding service flow sent by the UE/user device may be considered and treated as a variable as well, depending on delivery successes/failures of previous packets from the UE according to the requirement on the consecutive packet errors. In this case, even if the UE needed to send one small packet per Tp interval for the corresponding service flow, the serving network might need to provide the UE with upgraded resources in order to guarantee (or at least increase the reliability of) the delivery success for a certain packet of the corresponding service flow sent by the UE, given that the serving network failed to deliver previous packet(s) of the corresponding service flows.

Therefore, techniques are described that may allow a more flexible use of SPS based UL CGs for transmission of service flows, such as for service flows that may have variable packet sizes and/or variable data amounts to be transmitted within a latency requirement, or for service flows or data that may have variable or different reliability requirements, while improving flexibility and efficiency for resource allocation.

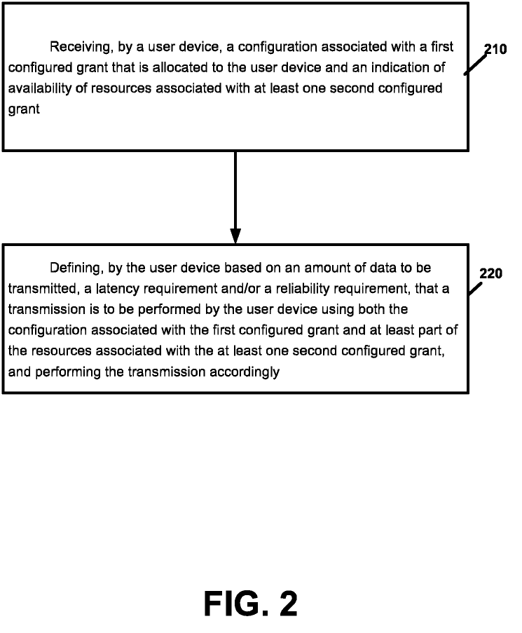

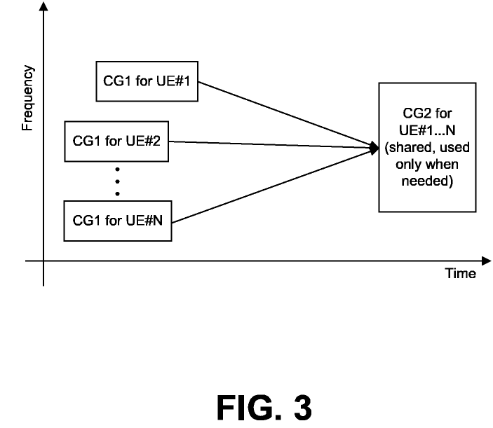

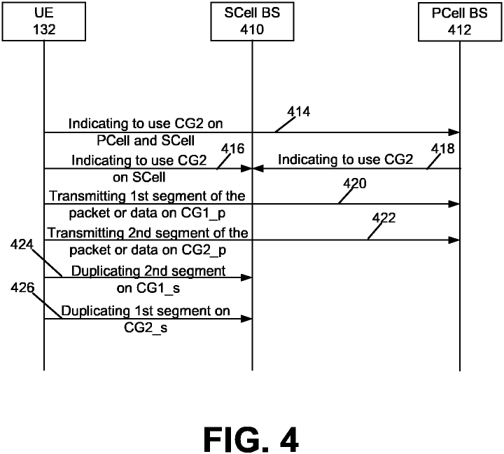

FIG. 2 is a flow chart illustrating operation of a user device (UE) according to an example embodiment. The method of FIG. 2 may use configured grants based on the configured grants (e.g., CG1, CG2) as shown in FIG. 3. Also, the method of FIG. 2 may use multi-connectivity as shown in FIG. 4.

As shown in the flow chart of FIG. 2, a method may include receiving (210), by a user device (or UE), a configuration associated with a first configured grant that is allocated to the user device (or UE) and an indication of availability of resources associated with at least one second configured grant, For example, the UE may receive a first configured grant that includes a resource (e.g., time-frequency resources) that may be dedicated to the UE for uplink transmission. The UE may also receive a second configured grant (or, alternatively, at least one second configured grant). The second configured grant may include a dedicated or shared resource(s) (e.g., shared time-frequency resources that may be used by multiple UEs, including the UE, for uplink transmission).

Also, as shown in the flow chart of FIG. 2, the method of FIG. 2 may also include defining (220), by the user device (e.g., UE), based on an amount of data to be transmitted and/or a latency requirement, that a transmission is to be performed by the UE using both the configuration associated with the first configured grant and at least part of the resources associated with the at least one second configured grant, and performing the transmission accordingly. The defining may include, for example, determining, by the UE, that the amount of data to be transmitted by the UE exceeds a maximum data amount of the first configured grant. Performing the transmission accordingly may include, for example, transmitting the amount of data via both the first configured grant and the (e.g., at least one) second configured grant, e.g., such as transmitting a first portion of the data via the first configured grant and a second portion of the data via the second (e.g., at least one) second configured grant.

With respect to the method of FIG. 2, the defining may include, for example, determining, by the UE, that the reliability requirement of data to be transmitted by the UE exceeds a reliability threshold of the first configured grant (or the reliability requirement of the data exceeds a reliability threshold (or reliability performance) that can be provided via use of only the first configured grant/CG1). Performing the transmission accordingly may include, for example, transmitting the same data via both the first configured grant and the (e.g., at least one) second configured grant, e.g., such as transmitting the data via both the first configured grant and the second (e.g., at least one) second configured grant. Thus, the data to be transmitted may be transmitted via the first CG (CG1), and then a duplicate of (e.g., all or a part of) the data may (in an illustrative example) be transmitted via at least one second CG (e.g., via at least one CG2), e.g., in order to increase a reliability of the data transmission by the UE/user device. Thus, to increase reliability of the data transmission, at least a portion of the data may be transmitted via both CG1 and CG2. For example, (all or part of) the data (e.g., duplicate data) may be transmitted via both CG1 and CG2 (e.g., the data transmitted via CG1, and a duplicate of (all or part of) that data also transmitted via CG2), or different redundancy versions of the data may be transmitted via CG1 and CG2, as illustrative examples of how the data may be transmitted via both CG1 and CG2 in a manner to increase the reliability of the UE data transmission.

The method of FIG. 2 may use configured grants as shown in FIG. 3. FIG. 3 is a diagram illustrating an allocation of configured grants according to an example embodiment. As shown in FIG. 3, a dedicated configured grant (e.g., CG1) may be configured to each UE, while at least one shared configured grant (CG2) may be allocated to a group or plurality of UEs, or shared among the plurality of UEs for an efficient resource use. It is noted that from the UE perspective the UE may not need to know whether an CG allocated to the UE is dedicated to the UE or shared with other UE. A first configured grant (CG1) is allocated or configured for UE#1 that may include a dedicated time-frequency resource (allocated to UE#1, for UL transmission). Likewise, another first (dedicated) configured grant (CG1) is also allocated or configured for UE#2, and a first configured grant (CG1) allocated or configured for UE#3, via different time-frequency-spatial resources. In this example, the CG1s (or first configured grants) for each of UE#1, UE#2 and UE#3 may include resources that may overlap (partially or fully) in time, and may use different frequency resources (e.g., different subcarriers). Each of these CG1s may include, for example, dedicated resources that may be dedicated or allocated to a particular UE (e.g., UE#1, UE#2, or UE#3). In addition, at least one second CG (e.g., CG2), may be configured or allocated for a plurality of UEs, including for UE#1, UE#2 and UE#3, and may include shared time-frequency resources that may be shared by one or more or all of these UEs, for example. In an example embodiment, any of the UEs (e.g., UE#1, UE#2, UE#3) may define (or determine), based on an amount of data to be transmitted by the UE and/or a latency requirement (e.g., packet delay budget for the data to be transmitted), that a transmission is to be performed by the UE using both the first configured grant (CG1) allocated to the UE, and at least part of the resources of the second configured grant (CG2). The UE may transmit the data via the first configured grant (CG1) and the second configured grant (CG2), as determined or defined (e.g., in an example embodiment, the second configured grant may be used for transmission by the UE if the maximum data amount of the first configured grant is not sufficient to accommodate or transmit the amount of data to be transmitted within the latency requirement). Thus, in an illustrative example embodiment, the second configured grant (CG2) may be used by any of the UEs, e.g., if the amount of data to be transmitted by the UE exceeds the maximum data amount of the first configured grant (CG1) allocated to the UE. This may allow CGs to be used to accommodate different packets sizes and/or different amounts of data to be transmitted via CGs, while avoiding wasting or inefficient use of resources.

Thus, the method of FIG. 2 may be based on using at least one UL CG for a preconfigured transport block (TB) size (TBS) (or maximum data amount) of Ld dedicated for an individual UE, referred to as CG1 (e.g., CG1, FIG. 3), coupled with (or which may be used with) at least one associated UL CG for a preconfigured TBS (or maximum data amount) of Ls which can be shared for multiple UEs or even all relevant UEs, referred to as CG2 (e.g., CG2, FIG. 3), in a serving cell of the individual UE serving one or more service flows (e.g., URLLC service flows) with variable packet sizes or variable instantaneous data rates.

In this manner, with respect to the method of FIG. 2, and with reference to FIG. 3, the defining (of the method of FIG. 2) that a transmission is to be performed by the user device may include determining that a transmission is to be performed via both the first configured grant (e.g., CG1, FIG. 3) and the second configured grant (CG2, FIG. 3), based on an amount of data to be transmitted, a latency requirement of the data or service flow associated with the data, and/or a reliability requirement of the data or of the service flow associated with the data. Thus, the UE may make a decision to transmit (e.g., for a TTI or subframe) using both the first configured grant (CG1, FIG. 3) and the second configured grant (CG2, FIG. 3), if either: 1) the amount of data to be transmitted exceeds the maximum data amount of CG1 (e.g., in such case, the amount of data that may be transmitted using CG1 within the latency requirement), and in such case, for example, a first portion of the data may be transmitted via CG1, and a second portion of the data may be transmitted via CG2; and/or 2) if a reliability for a transmission of the data via only CG1 would be less than (or is estimated to be less than) a reliability requirement for the data (e.g., in such case, the amount of data may be transmitted via both CG1 and at least one CG2, such that at least a portion of the data, or even all of the data may be transmitted via both CG1 and CG2 to improve reliability, e.g., which may thus be used as a technique to improve or increase the reliability of the data transmission, for example). One or more second CGs (one or more CG2s) may be selected and then used by the UE (e.g., in addition to CG1), for example, as needed to meet the amount of data requirement, latency requirement, and/or reliability requirement for the data to be transmitted.

Also, with respect to the method of FIG. 2, the at least one second configured grant (e.g., CG2, FIG. 3) may indicate at least a shared resource that can be used, in addition to a dedicated resource of the first configured grant (e.g., CG1, FIG. 3), for uplink transmission by the UE/user device if the amount of data to be transmitted by the UE within the latency requirement exceeds a maximum data amount of the first configured grant. Thus, the UE may determine, for example, if the amount of data to be transmitted exceeds a maximum data amount of the first configured grant. Thus, if the amount of data to be transmitted does not exceed the first configured grant (e.g., does not exceed the amount of data that can be transmitted via the first configured grant within the latency requirement), then the amount of data may be transmitted by the UE via the first configured grant (e.g., and use of the second configured grant in such case is unnecessary to transmit the data within the latency requirement, since the data transmission within the latency requirement can be accommodated by the first configured grant). On the other hand, if the amount of data to be transmitted by the UE exceeds the maximum data amount of the first configured grant (e.g., the amount of data to be transmitted within the latency requirement exceeds the maximum data amount of the first configured grant or which can be transmitted via the first configured grant within the latency requirement), then the UE is configured to use both the first configured grant and the second configured grant to transmit the amount of data within the latency requirement (e.g., the UE transmits a first portion of the data via the first configured grant, and transmits a second portion of the data via the second configured grant, e.g., where the first configured grant and the second configured grant may have different time-frequency resources).

Also, with respect to the method of FIG. 2, the at least one second configured grant (e.g., CG2, FIG. 3) may indicate at least a shared (or, alternatively, a dedicated) resource that can be used, in addition to a dedicated resource of the first configured grant (CG1, FIG. 3), for uplink transmission by the UE/user device if the (expected or estimated) reliability of the transmission of the data via only the first configured grant would not meet a reliability requirement of the data (or of the service flow associated with the data). In such case, the data (or amount of data) may be transmitted by the UE via both the first configured grant and via the second configured grant, e.g., in order to increase a reliability of the UE data transmission such that the transmission reliability (via use of both first and second configured grants) will (or is estimated to) meet or exceed the reliability requirement of the data or service flow. All or part of the data may be transmitted via both the first configured grant (e.g., CG1, FIG. 3) and the second configured grant (CG2, FIG. 3). For example, a duplicate of the data may be transmitted via both first configured grant (CG1) and second configured grant (CG2), or same or different redundancy versions of the data may be transmitted via first configured grant and second configured grant.

The method of FIG. 2 may further include transmitting, by the UE, an indication that the UE is transmitting data via the at least one second configured grant (e.g., CG2, FIG. 3). Thus, the UE may send an indication to a network node (e.g., BS, gNB, ...) to indicate that the UE is transmitting data via the second configured grant (e.g., CG2, FIG. 3), which may indicate, that data is transmitted via both the first configured grant (CG1, FIG. 3) and the second configured grant (CG2, FIG. 3). Also, with respect to method of FIG. 2, a layer 1 or layer 2 signaling may be used by the UE to indicate that it is transmitting via the second configured grant, e.g., such as the UE transmitting a reference signal, such as a demodulation reference signal (DMRS), that is, e.g., associated with (or specific to) the second configured grant, indicates transmission by the UE via the second configured grant. Other signals may be used to indicate that the UE is transmitting via the second configured grant.

Also, with respect to the method of FIG. 2, the second configured grant may be associated with the first configured grant, e.g., which may include or may mean, in an illustrative example embodiment, that the UE may transmit an amount of data via (e.g., the total or cumulative resources of) both of the first configured grant (e.g., CG1, FIG. 3) and the associated second configured grant (e.g., CG2, FIG. 3). Thus, these two associated configured grants (e.g., CG1, CG2, FIG. 3) may be used by a UE to transmit an amount of data within a latency requirement (e.g., within a packet delay budget). A first portion of the data may be transmitted via the first configured grant, and a second portion of the data may be transmitted via the second configured grant. Or, the second configured grant being associated with the first configured grant may mean or may include that the user device may transmit an amount of data via the first configured grant and the second configured grant, including transmitting a first portion of the amount of data via the first configured grant and a second portion of the amount of data via the second configured grant, if the amount of data exceeds a maximum data amount of the first configured grant. The network node or BS may indicate (e.g., such as a signal or flag provided within the configuration of the first configured grant and/or within the configuration of the second configured grant, or other signal) to the UE that the second configured grant is associated with the first configured grant. The association indication, e.g., which may be signaled or indicated by the BS to the UE, may indicate that there is an association or linkage between these two configured grants (CG1, CG2, FIG. 3), e.g., that may indicate that the UE, at least under one or more situations, may use both the first configured grant (CG1. FIG. 3) and the second configured grant (CG2, FIG. 3) to transmit an amount of data or a block of data, such as a packet or multiple packets, or other amount of data).

Also, with respect to the method of FIG. 2, the UE may optionally use the second configured grant (e.g., CG2, FIG. 3) to transmit a portion of the amount of data to be transmitted by the UE, e.g., when the amount of data to be transmitted by the UE exceeds the maximum data amount of the first configured grant (e.g., CG1, FIG. 3) that is allocated to the UE. In an example embodiment, the use of the second configured grant (CG2) by the UE may be indicated by the UE to a serving BS (serving network node) in advance (e.g., in advance of or prior to the time of the CG2 time-frequency resources) so that the serving BS can reschedule at least a part of CG2 for UL data transmissions of other UEs dynamically when CG2 is not used by a UE. That is, for example, in case no such indication is received at the serving BS (no indication is received by BS indicating that the UE is not transmitting via CG2 for a TTI), the resources of CG2 can be re-allocated by the BS/network node to another UE(s) by the serving BS. There may be different options or implementations for realizing or providing this indication.

Also, with respect to the method of FIG. 2, the data may include, e.g., a first segment (or first portion) of a packet transmitted via the first configured grant (CG1, FIG. 3), and a second segment (or second portion) of the packet transmitted via the second configured grant (CG2, FIG. 3). Or, the data may include a first packet associated with a first data flow (or first service flow) that is transmitted via the first configured grant (CG1, FIG. 3), and a second packet associated with a second data flow (or a second service flow) that is transmitted via the second configured grant (CG2, FIG. 3), as some illustrative examples. Or, the data may include a packet transmitted via the first configured grant (CG1, FIG. 3) and the same packet transmitted via the second configured grant (CG2, FIG. 3) (data duplication).

Also, with respect to the method of FIG. 2, a first configured grant (e.g., CG1, FIG. 3) may be provided for or associated with a quality of service (QoS), or a logical channel of a QoS level or a logical channel group. A Quality of Service (QoS) profile (e.g., which may be inherited from that of the one or more service flows with variable enough packet sizes or instantaneous data rates) may be characterized by (or associated with), among other parameters, Lm (amount of data to be transmitted by the UE) and Tp (latency requirement), wherein resources allocated for the first configured grant (CG1) (with a maximum data amount of CG1 of Ld) and a second configured grant (CG2) (with a maximum data amount of CG2 of Ls) should ensure that Sum(Ld, Ls) >= Lm and there is one transmission occasion per each CG available within/per Tp. Thus, in this illustrative example, the sum of maximum data amounts of CG1 and CG2 (Ld+Ls) may be greater than or equal to Lm (the maximum amount of data to be transmitted by the UE per Tp). This may allow the amount of data to be transmitted (e.g., a packet, or multiple packets, or other amount of data to be transmitted), within latency restriction (Tp) or maximum packet latency, to be handled or accommodated by the cumulative (or sum of) time-frequency resources of the CG1 and at least one CG2, and may ensure that the amount of data to be transmitted can be transmitted within the latency restriction (Tp) or maximum packet delay (or maximum transmission delay, or maximum transmission latency).

Also, with respect to the method of FIG. 2, a maximum packet size or amount of data may be defined per configured grant, that is to say separately for first configured grant (e.g., CG1, FIG. 3)) and the second configured grant (e.g., CG2, FIG. 3). The second configured grant, e.g., CG2 (e.g., the group-based configured grant), may be used by the UE when the amount of data needed to be transmitted within/per the set maximum packet delay budget Tp exceeds the maximum packet size or amount of data possible to be transmitted per first configured grant (CG1, FIG. 3) (the dedicated configured grant) Ld. The maximum packet size or amount of data possible to be transmitted per CG2 may be denoted herein as Ls. Also, the maximum packet size or amount of data may be defined per a service flow denoted as Lm. This may be specified as an additional parameter in quality of service (QoS) profile or given as dependent on maximum flow bit rate (MFBR) as Lm=Tp*MFBR (maximum flow bit rate). In an example embodiment, the maximum packet size or maximum amount of data that can be transmitted per CG1 and CG2 (e.g., Ld and Ls) may (or should) fulfill the condition that Ld+Ls >= Lm. Configuration of the first configured grant and the second configured grant (e.g., CG1 and CG2, FIG. 3) may be applied when CG1 and CG2 are configured by the same gNB or different gNBs in dual/multi connectivity using distributed coordination. Packet delay budget (or latency requirement or packet periodicity) Tp may be set based on the service requirement. The data division (or data segmentation of the data for transmission) needed between CG1 and CG2 for the current Tp which can be due to a segmentation of a large packet and/or a concatenation or distribution of more than one packets. Furthermore, the reliability threshold of (or maximum reliability performance that can be achieved by) the transmission of data using only CG1 may be set by the serving gNB based on some provisioning and/or measurement (e.g., corresponding to a most robust MCS option for CG1) for example. The reliability requirement of the data or service flow which has the consecutive error requirement, may be adjusted on individual packets based on the requirement on consecutive packet errors for example. Thus, the UE may be configured to determine the reliability requirement on the data (individual packets of a service flow) to be transmitted based on monitoring consecutive packet errors (on data transmission of the service flow) for example.

With respect to the method of FIG. 2, a (at least one) second configured grant (e.g., CG2, FIG. 3) may be used by the UE when (e.g., or only when) the amount of data to be transmitted (or needed to be transmitted) by the UE within/per Tp exceeds Ld (maximum data amount) of the first configured grant (e.g., CG1, FIG. 3). Likewise, with respect to the method of FIG. 3, a UE may use only the first configured grant (CG1, FIG. 3) (and not use, or not need to use the second configured grant, CG2 (FIG. 3)) for a data transmission if the amount of data to be transmitted is less than or equal to a maximum data amount of CG1 (e.g., thus, no need to also use CG2 in that situation to transmit the data, since CG1 is sufficient). Thus, a data division (or segmentation of the data to be transmitted) may be needed between the first configured grant (CG1, FIG. 3) and the second configured grant (CG2, FIG. 3) (e.g., to assign or determine a first portion of the data to be transmitted via CG1, and to assign or determine a second portion of the data to be transmitted via CG2) for the current Tp which can be based on a segmentation of a large packet into two data segments and/or a concatenation and/or distribution of more than one packet among CG1 and CG2. In this manner, the first configured grant (e.g., CG1, FIG. 3) and the second configured grant (e.g., CG2, FIG. 3) may be associated with each other, e.g., where such association may mean or may include that a UE may transmit an amount of data via the cumulative or total (or combined) time-frequency resources of the first configured grant (CG1, FIG. 3) and the second configured grant (CG2, FIG. 3). Alternatively, such association between the first configured grant (e.g., CG1, FIG. 3) and the second configured grant (e.g., CG2, FIG. 3) may mean or may include that an amount of data may be transmitted by the UE via cumulative (or total or combined) resources of CG1 and CG2 if the amount of data to be transmitted (Lm) exceeds the maximum data amount (Ld) of the first configured grant (e.g., CG1, FIG. 3), or if a reliability requirement of the data cannot be met based on a data transmission via only resources of the first configured grant (CG1, FIG. 3). Therefore, in some cases, use of CG2 may be optional, e.g., depending on need of the UE. In an example embodiment, the needs (or requirements) of the UE is not only due to the amount of the data to be transmitted (e.g., within the latency requirement) that may vary from time to time, but also due to the reliability requirement of the data to be transmitted, which may vary from time to time as well. In an example embodiment, a UE may use CG1 (and not use, or not need to use, CG2) for a data transmission if the reliability requirement on the data (packet) to be transmitted is less than or equal to the reliability threshold of (reliability performance offered by) CG1 (e.g., thus, no need to also use CG2 in that situation to duplicate the data for enhancing reliability, since CG1 is sufficient to meet or satisfy the reliability requirement of the data).

Also, with respect to the method of FIG. 2, the configuration of the first configured grant (e.g., CG1, FIG. 3) may be provided by a BS or gNB to the UE via dedicated signaling, such as via dedicated radio resource control (RRC) message and/or dedicated downlink control information (DCI). CG configuration parameters may include a periodicity, time frequency resources (e.g., which may be indicated by identifying frequency resources and time offset for example via TDRA (time domain resource allocation) table), modulation and coding scheme (MCS), and/or other parameters. For the configured of the first configured grant (e.g., CG1, FIG. 3) (or the CG that is allocated or dedicated to a UE), a dedicated time-frequency resources may be indicated as part of the CG1 configuration. Also, with respect to the method of FIG. 2, the second configured grant (e.g., CG2, FIG. 3) (or a CG that may be shared among, or allocated to, a plurality or group of UEs) may have a portion of the CG2 configuration provided by the BS/gNB via common signaling (such as via broadcast system information block (SIB)), since the multiple UEs (that share CG2) will be allocated the same time-frequency resources and/or have the same periodicity for CG2. In addition, with respect to the method of FIG. 2, for CG2, a portion of the CG2 configuration may be provided or indicated to each UE via dedicated signaling (e.g., dedicated RRC, and/or dedicated DCI signaling, that is dedicated or sent to each UE), since one or more CG2 configuration parameters may be specific to each UE. For example, the BS-UE channel (channel characteristics) may be different for each UE. Thus, with respect to the method of FIG. 2, one or more CG2 configuration parameters, such as a modulation and coding scheme (MCS) (which may be based on a channel between the UE and BS) may be UE specific and may be sent or provided by the BS to each UE via dedicated signaling, since a UE-specific MCS may be assigned or configured for CG2 for each UE. While, for example, as noted, at least one parameter of the configuration of CG2 (e.g., time-frequency resources and/or periodicity, and/or time offset of the CG resources) may be the same for multiple or all UEs, and thus, may be communicated by the BS/gNB to all UEs via common signaling.

Also, the method of FIG. 2 may be performed based on UE multi-connectivity as shown in FIG. 4, in which a UE 132 may be connected to both a primary cell (provided by a primary cell BS (PCell BS 412) and a secondary cell (provided by a secondary cell BS (SCell BS 410)). FIG. 4 is a diagram illustrating multi-connectivity for a user device (or UE). UE 132 may be connected to a primary cell (PCell) BS 412 (providing the primary cell). The UE 132 may, in some cases, also be connected to a secondary cell (SCell) BS 410 (that provides the secondary cell), where the PCell and SCell may provide dual or multi-connectivity for the UE 132. In an example embodiment, multi-connectivity may be used, e.g., for data duplication, such as PDCP data duplication, for improved reliability, where an amount of data may be transmitted over two CGs (CGI_p, CG2_p) for the primary cell (PCell), and a duplicate of the data may be transmitted via two other CGs (e.g., CG1_s, CG2_s), where CG1_p and CG2_p are the dedicated and shared CGs, respectively, for the primary cell and CG1_s and CG2_s are the dedicated and shared CGs, respectively, for the SCell.

With respect to FIGS. 2 and 4, the CGs of the primary cell and CGs of the secondary cell may use different resources (different time-frequency resources) and/or different frequency resources (different subcarriers), since the PCell and SCell may be provided, for example, on different carriers (different carrier frequencies). The four different CGs may also have different configurations, e.g., different time-frequency resources (including different maximum data amounts), MCS, transport block size (TBS), or other configuration parameters. PCell BS 412 may configure the CGs for the PCell and SCell, and send the configurations for the CGs for PCell and SCell to the UE 132. Or, PCell BS 412 may configured PCell CGs, and SCell BS 410 may configure SCell CGs. If SCell BS 410 configures CGs of the SCell, the SCell BS 410 may then report to PCell the configuration of the SCell CGs and that it has configured these CGs of the SCell. For example, SCell BS 410 may configure SCell CGs, and then may provide these SCell CG configurations to the PCell BS 412, and then the PCell BS 412 may send to the UE the configurations of the CGs for both the PCell and the SCell. If the UE 132 has a connection (e.g., secondary RRC connection between UE 132 and SCell BS 410) to the SCell, the SCell may provide the SCell CG configurations directly the UE 132. Also, the UE 132 may use the CG1_p and CG1_s when the amount of data to be transmitted does not exceed the maximum data amount of CG2_p or CG2_s, where the data is transmitted via CG1_p and a duplicate of the data may be transmitted via CG1_s. If the amount of data to be transmitted exceeds the maximum data amount of CG1_p or CG1_s, the amount of data to be transmitted may be divided into a first portion and a second portion (or a first segment and a second segment). The PCell BS 412 and the SCell BS 410 may coordinate (communicate and agree) on the data or amount of data to be transmitted via each of the CGs of the PCell and SCell. For example, the PCell BS 412 and the SCell BS 410 may agree or may coordinate that the first segment of the data is transmitted via CG1_p and CG2_s (as a duplicate of the first segment on CG2_s), and the second segment of the data is transmitted via CG2_p and CG1_s (as a duplicate of the second segment via CG1_s).

With respect to FIGS. 2 and 4, the UE 132 may determine to use the second CGs (CG2_p and CG2_s, corresponding to a CG2, FIG. 3) (e.g., in addition to CG1_p and CG1_s) for a large packet, or an amount of data in a current Tp. For example, the UE 132 may determine that an amount of data to be transmitted exceeds a maximum data amount of CG1_p or CG1_s, and thus, may need to also use CG2_p and CG2_s to transmit the amount of data within Tp, for example. At 414, UE 132 may send or provide an indication to PCell BS 412 that a second CG (CG2_p and CG2_s) is used for each of PCell and SCell. At 416, the UE 132 may send an indication to SCell BS 410 that indicates that CG2_s is used for the transmission from the UE 132. Or, instead of the operation 416, the PCell BS 312 may send an indication to SCell BS 310 that the transmission from UE 132 uses CG2_s. At 420, the UE may then transmit the first segment of the amount of data to the PCell or to the PCell BS 412 via CG1_p. At 422, the UE 132 may transmit the second segment of the data to the PCell or to the PCell BS 412 via CG2_p. At 424, the UE 132 may transmit a duplicate of the second segment of the data to the SCell or to the SCell BS 310 via CG1_s. At 426, the UE 132 may transmit the duplicate of the first segment of the data to the SCell or to the SCell BS 310 via CG2_s.

Also, with reference to FIGS. 2 and 4, if the SCell (or SCell BS 410, FIG. 4) does not receive either the first portion of the data via CG2_s or the second portion of the data via CG1_s, then the SCell or SCell BS 410 may forward the portion that was correctly received by the SCell BS 410 to the PCell BS 412, with an indication of which secondary CG (CG1_s or CG2_s) the forwarded data was received over. In some cases, the SCell BS 410 may only forward data (the received segment of the packet) to the PCell BS 412 specifically for data combining (resembling of the packet) if only one of the segments is received by the SCell BS, but not both segments are received by the SCell BS 410. The PCell BS 412 may then perform data combining based on data received by PCell BS 412 from UE and data forwarded to PCell BS 412 to the SCell BS 410. It is noted that when the SCell BS 410 receives both of the segments (or portions) correctly, the SCell BS 410 may reassemble the packet and then forward the packet to the PCell BS 410 as in the current PDCP level multi-connectivity. This way, variable packet sizes can be supported with preconfigured transport block (TB) size(s) of the configured grant.

With respect to the method of FIG. 2, and with reference to FIG. 4, the network, e.g., a serving BS, such as a serving primary BS in the case of multi-connectivity, or other network node, may indicate or signal to the UE an association between a CG1 and a CG2 for the UE, e.g., by including or providing a signal within a configuration (or at least part of a configuration) of CG1 or CG2, that may indicate the other CG (e.g., CG2 or CG1) is an associated CG (and thus, indicate to the UE that the cumulative or total resources of these two CGs, at least under certain conditions, may be used by the UE to transmit an amount of data). For example, a serving BS or network node may include within a configuration of a first configured grant (e.g., CG1, FIG. 3) provided to the UE, an indication of at least one second configured grant (e.g., CG2, FIG. 3) that is associated with the first configured grant (CG1). Or, a serving BS or network node may include within a configuration of the second configured grant (CG2, FIG. 3) that is provided to the UE, an indication or identification of an associated first configured grant (e.g., CG1, FIG. 3).

Also, with respect to the method of FIG. 2, and the multi-connectivity shown in FIG. 4, the UE may be configured for multi-connectivity to allow the UE to transmit via both a primary cell and a secondary cell. In such case, various configurations or arrangements may be provided with respect to the method of FIG. 2, such as: both the first configured grant and the at least one second configured grant are provided for the primary cell, or both the first configured grant and the at least one second configured grant are provided for the secondary cell, or the first configured grant is provided for the primary cell and the at least one second configured grant is provided for the secondary cell, or the first configured grant is provided for the at least one secondary cell and the second configured grant is provided for the primary cell.

The method illustrated in FIG. 2 may also include using the multi-connectivity (e.g., see FIG. 4) for data duplication of the uplink data transmission in which case a network node providing the primary cell and a network node providing the secondary cell coordinate the configuration of the first configured grant and the configuration of the at least one second configured grant. Thus, a network node providing (or associated with) the primary cell may communicate with a network node providing (or associated with) the secondary cell, and these nodes may coordinate or arrange the configured grants for the primary cell and the secondary cell. Or, with respect to the method of FIG. 2, the network node of the primary cell may configure or determine the configured grants of both the primary cell and the secondary cell. Or with respect to the method illustrated in FIG. 2, the network node of the primary cell may determine or configured the configured grants of the primary cell (e.g., first configured grant and second configured grant, associated with the first configured grant, of the primary cell), and the network node of the secondary cell may determine or configured the configured grants of the secondary cell (e.g., a third configured grant and a fourth configured grant associated with the third configured grant, of the secondary cell).

With respect to the method of FIG. 2, and also with reference to FIG. 4, in case a data duplication using multi-connectivity (e.g., Packet Data Convergence Protocol (PDCP) data duplication) is applied using CGs on different carriers (e.g., within a primary cell and a secondary cell), the amount of data to be transmitted may be transmitted via the primary cell (PCell), and a duplicate of the data may be transmitted via the secondary cell (SCell). In such case, two CGs (e.g., a dedicated CG1 and a shared CG2) may be provided for the PCell, and two CGs (a dedicated CG1 and a shared CG2) may be configured for the SCell. A coordination may be performed between the primary serving BS (that provides the PCell) and secondary BS (providing the SCell for the UE), e.g., messages may be exchanged between primary BS and secondary BS to determine or agree on the data to be transmitted on the CGs of the PCell and SCell. For example, this coordination between primary BS and secondary BS may coordinate or determine that a first portion of the data is transmitted on a CG1 of the PCell and a CG2 of the SCell, and a second portion of the data may be transmitted on the CG2 of the PCell and the CG1 of the SCell. Also, for example, PCell and SCell may coordinate on Ld and Ls of CG1 and CG2 on PCell and SCell, as well as the part (or portions) of the data transmitted on CG1s of PCell and SCell. Also, for example, SCell may forward the data received on either CG1 or CG2 alone to PCell (in a case where either the first portion or the second portion of data is received correctly at SCell) for a macro-diversity combining at PCell (where the primary BS performs macro-diversity combining of data received by PCell and data received by SCell that was forwarded to PCell).

With respect to the method of FIG. 2, when packet duplication is provided using PCell and SCell, a coordination between SCell and PCell may be performed. For example, if SCell receives only one of the data portions (e.g., received via either CG1 or CG2 of SCell), then the SCell may forward the received data portion to the PCell, and may indicate either CG1 or CG2, to indicate that data was received on either CG1 or CG2 by the SCell. The primary BS (providing the PCell) may then perform macro-diversity combining, or data combining, to combine the data received by the PCell and the data (or data portion) forwarded from SCell to PCell (or forwarded from primary BS to secondary BS).

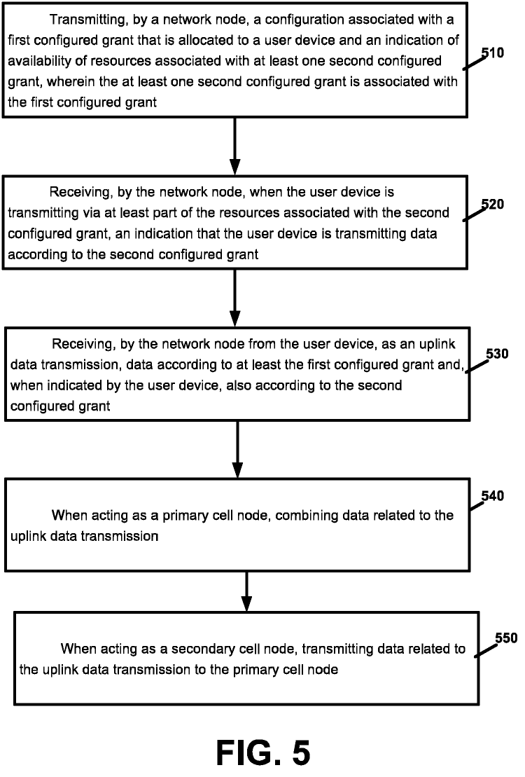

FIG. 5 is a flow chart illustrating operation of a network node (e.g., BS or gNB) according to an example embodiment. The method of FIG. 5 may use configured grants based on the configured grants (e.g., CG1, CG2) as shown in and described for FIG. 3. Also, the method of FIG. 5 may use multi-connectivity as shown in and described for FIG. 4. With respect to the method of FIG. 5, operation 510 includes transmitting, by a network node (e.g., BS or gNB), a configuration associated with a first configured grant (e.g., CG1, FIG. 3) that is allocated to a user device (e.g., UE 132 of FIG. 1, or of FIG. 4) and an indication of availability of resources associated with at least one second configured grant (e.g., CG2, FIG. 3), wherein the at least one second configured grant is associated with the first configured grant. For example, the network node or gNB may transmit a configuration of a first configured grant (e.g., CG1, FIG. 3), with a resource allocated to the UE, and the network node may communicate (e.g., broadcast or group-based signaling) a configuration of at least one second configured grant (e.g., CG2, FIG. 3) with shared resources. For example, CG1 and CG2 may be configured to the UE (e.g., the network may send a message(s) or signaling to indicate the configurations of CG1 and CG2 for the UE). CG1 and CG2 can be configured by the serving cell or dual/multi connectivity may be applied (e.g., as shown in FIG. 4) and both or either of the CG1 and CG2 may be configured by a secondary cell. However, CG1 and CG2 may be different for the primary cell (PCell) and the secondary cell (SCell), though. The cell may be indicated by cell ID. In the case of packet duplication, the first transmissions may be carried out in the primary cell and the duplicate transmissions in the secondary cell, and vice versa for example. The network node or BS may send to UE a first configured grant (e.g., CG1, FIG. 3) that includes a resource (e.g., time-frequency resources) that may be dedicated to the UE for uplink transmission, and a second configured grant (e.g., CG2, FIG. 3) (or, alternatively, at least one second configured grant). The second configured grant (CG2, FIG. 3) may include a dedicated or shared resource(s), e.g., shared time-frequency resources that may be used by multiple UEs, including the UE, for uplink transmission. Also, for example, the second configured grant (e.g., CG2, FIG. 3) being associated with the first CG (CG1) may mean or may include, for example, that the UE may transmit an amount of data via (e.g., via the total or cumulative resources of) both of the first configured grant (CG1, FIG. 3) and the associated second configured grant (CG2, FIG. 3). In some cases, certain conditions may be applied, at least in some example embodiments, that indicate the conditions under which the UE may be allowed to use the CG2 (in addition to CG1), e.g., so as to allow the data to be transmitted within the latency requirement, and/or to improve reliability or to meet a reliability requirement of the data. For example, a first portion of the data may be transmitted via the first configured grant (e.g., CG1, FIG. 3) and a second portion of the data may be transmitted via the second configured grant (e.g., CG2, FIG. 3). Or, data duplication may performed by the UE, e.g., by transmitting the data (or at least a portion of the data) via both the first configured grant (e.g., CG1, FIG. 3) and the second configured grant (e.g., CG2, FIG. 3) (e.g., this may include same data, or same or different redundancy versions being transmitted via CG1 and CG2).

Operation 520 of the method of FIG. 5 may include receiving, by the network node (e.g., gNB or BS), when the user device (e.g., UE) is transmitting via at least part of the resources associated with the second configured grant (e.g., CG2, FIG. 3), an indication that the user device is transmitting data according to the second configured grant. See, e.g., operations 414 and/or 416, FIG. 4, where the UE 132 may send or transmit an indication (e.g., to a network node, such as to a SCell BS 410 and/or to PCell BS 412) that the UE is transmitting on CG2. This indication may be received by the network node, and may allow the network node (e.g., gNB or BS) to receive data via information transmitted via both the first configured grant (e.g., CG1, FIG. 3) and second configured grant (e.g., CG2, FIG. 3). If no indications is provided that a transmission is being performed on CG2, the network node may, for example, reallocate resources of CG2 to another UE or for other purpose. Thus, for example, the UE may send an indication to a network node (e.g., BS, gNB, ...) to indicate that the UE is transmitting data via the second configured grant, which may indicate, that data is transmitted via both the first configured grant (CG1, FIG. 1) and the second configured grant (CG2, FIG. 2). In an illustrative example embodiment, a layer 1 or layer 2 signaling may be used by the UE to indicate to the network node that the UE is transmitting via the second configured grant (CG2, FIG. 3), e.g., such as the UE transmitting a reference signal, such as by transmitting a demodulation reference signal (DMRS), that is, e.g., associated with (or specific to) the second configured grant, or indicates transmission by the UE via the second configured grant. Other signals may be used to indicate that the UE is transmitting via the second configured grant.

Operation 530 of FIG. 5 includes receiving, by the network node (e.g., BS or gNB) from the user device (e.g., UE), as an uplink data transmission, data according to at least the first configured grant (e.g., CG1, FIG. 3) and, when indicated by the user device (UE), also according to the second configured grant (e.g., CG2, FIG. 3). See, e.g., one or more of operations 420-426, as an illustrative example, where the network node (e.g., BS/gNB, such as nodes 410 and/or 412) may receive the data transmitted by the UE via resources of both CG1 and CG2.

Operation 540 of FIG. 5 includes when the network node is acting as a primary cell node, combining data related to the uplink data transmission. For example, the network node (e.g., gNB or BS), when acting as a PCell BS 412 (e.g., FIG. 4), may receive data from the UE, and may receive data forwarded by the SCell, and then may combine (macro-combining) both data. And, operation 550 of FIG. 5 includes: Or, when acting as a secondary cell node, transmitting data related to the uplink data transmission to the primary cell node. For example, when the network node (e.g., BS or gNB) is operating as a SCell BS 410 (FIG. 4), may forward received data to the PCell BS 412 (FIG. 4) for macro-combining. Thus, with respect to the method of FIG. 5, the network node may operate as either a primary cell (PCell) node, or a secondary cell (SCell) node.

With respect to the method of FIG. 5, the first configured grant (e.g., CG1, FIG. 3) may include a dedicated resource (e.g., a resource for UL transmission allocated to the UE) for the user device/UE and the at least one second configured grant (e.g., CG2, FIG. 3) may include a shared resource (e.g., a resource for UL transmission made available to a plurality of UEs, at least under certain conditions) available for a plurality of user devices/UEs for uplink transmission.

With respect to the method of FIG. 5, when the user device (UE) is configured for multi-connectivity (e.g., see FIG. 4) to allow the user device (UE 132, FIG. 4) to transmit via both a primary cell (PCell) and a secondary cell (SCell), both the first configured grant (e.g., CG1, FIG. 3) and the at least one second configured grant (e.g., CG2, FIG. 3) are provided for the primary cell, or both the first configured grant and the at least one second configured grant are provided for the secondary cell, or the first configured grant is provided for the primary cell and the at least one second configured grant is provided for the at least one secondary cell, or the first configured grant is provided for the secondary cell and the at least one second configured grant is provided for the primary cell. For example, different combinations of configured grants (e.g., CG1, CG2, FIG. 3) may be provided for PCell and SCell. The CG1, CG2 may be provided for the PCell, the SCell, or a mix.

With respect to the method of FIG. 5, the method may include coordinating (e.g., by the network node, or gNB) reservation of resources for the first configured grant (e.g., CG1, FIG. 3) and the at least one second configured grant (e.g., CG2, FIG. 3) with the primary cell and the secondary cell for data duplication in association with the uplink data transmission. For example, PCell BS 412 (FIG. 4) may coordinate or determine resources of primary cell and secondary cell, or PCell BS 4 may determine or coordinate only CG resources of the PCell, and SCell BS 410 (FIG. 4) may determine or coordinate CG resources of the SCell. The PCell BS 412 and the SCell BS 410 may communicate to establish these resources and/or determine what data will be transmitted over specific CG resources of specific cells.

With respect to the method of FIG. 5, when the coordinating reservation of resources is distributed, the primary cell node carries out configuration for the primary cell and the secondary cell node carries out configuration for the secondary cell; and wherein, when the coordinating reservation of resources is centralized, the primary cell node carries out configuration for both the primary cell and the secondary cell. For example, PCell BS 412 (FIG. 4) may coordinate or determine resources of primary cell and secondary cell (centralized), or PCell BS 412 may determine or coordinate only CG resources of the PCell, and SCell BS 410 (FIG. 4) may determine or coordinate CG resources of the SCell (distributed). The PCell BS 312 and the SCell BS 310 may communicate to establish these resources and/or determine what data will be transmitted over specific CG resources of specific cells.

With respect to the methods of FIGS. 2 and 5, in the case of retransmission (after BS sends a NACK indicating that the network node did not receive the data, for example), the second transmission may be carried out by the UE in the secondary cell when the first transmission has taken place in the primary cell. This may be pre-configured or dynamically indicated.

With respect to the methods of FIGS. 2 and 5, the network node may be informed by the UE of the usage of CG2 regardless whether it acts as the primary cell node or a secondary cell node. Also, the network node may indicate the configurations to UE(s) by using radio resource control (RRC) signaling, for instance. Information of shared CG2 resources may also be multicast or broadcast (or common signaling), whereas one or more parameters of the shared CG2 may be sent or transmitted by network node to the UE via dedicated signaling. For example, although the time-frequency resources of CG2 are the same for all relevant UEs sharing CG2, modulation and coding scheme (MCS) and therefore transport block size (TBS) may be configured dedicatedly and differently for the different UEs. The UE-specific part of the CG2 configuration information (e.g., MCS and therefore TBS) may be merged into (or included within) the RRC signaling used to provide or communicate the CG1 configuration to the UE. Hence, in some cases, a full configuration of CG2 may be based on the common information (time-frequency resources, and default MCS or TBS for all relevant UEs) in the system information block (SIB). Also, the network node may send the configuration of CG1 and CG2 via dedicated signaling (e.g., dedicated RRC messages). Network node may send the UE the CG2 configuration via common signaling, e.g., via system information block (SIB).

With respect to the methods of FIGS. 2 and 5, a maximum packet size or amount of data may be defined per configured grant, that is to say, separately for CG1 and CG2. In an example embodiment, CG2 (e.g., the group-based configured grant) may be used by the UE when the amount of data needed to be transmitted within/per the set maximum packet delay budget (or latency restriction) Tp exceeds the maximum packet size or amount of data possible to be transmitted per CG1 (the dedicated configured grant) Ld. The maximum packet size or amount of data possible to be transmitted per CG2 is denoted herein as Ls. In URLLC, for example, there can be more than one coordinated or synchronized service flows and therefore there may be a need to transmit more than one packet of different service flows within the same Tp interval. On the other hand, the data division needed between CG1 and CG2 for the current Tp can be due to a segmentation of a large packet and/or a concatenation or distribution of more than one packets. Therefore, in the case packet duplication is applied where PCell (primary cell) and SCell (secondary cell) is used, the first transmissions may be carried out in the primary cell and the duplicate transmissions may be performed or carried out in the secondary cell, for example. Both cells may be informed about the usage of CG2 within each cell. In the case of retransmission (after Nack, for example), the second transmission may be carried out in the secondary cell when the first transmission has taken place in the primary cell.

With respect to the method of FIGS. 2 and 5, there may be different options for the UE to indicate to the serving (or the primary and secondary) network node (e.g., gNB/BS), and for the serving network node (e.g., gNB or BS) to receive an indication, that the second configured grant (e.g., CG2, FIG. 3) (in addition to the associated first configured grant, e.g., CG1, FIG. 3) will be used for UL transmission from the user device (UE) to the network node (e.g., BS or gNB). In one option, assuming the transmission occasion on CG1 happens first (before transmission occasion for CG2) and there is a considerable time gap between the transmission occasions on CG1 and CG2 within/per Tp, the UE may indicate to the network node along with the transmission on CG1 that CG2 will be used by using either L1 or L2/L3 signaling. In an illustrative example, for CG1 the UE may send to network node (and network node may receive) a pre-allocated unique L1 UL DMRS (Demodulation Reference Signal) together with the UL transmission. The transmitted DMRS signal (transmitted by user device/UE and received by the network node) may be associated with the second configured grant (e.g., CG2, FIG. 3), or may indicate that the second configured grant (e.g., CG2, FIG. 3) is used for UL transmission, for example. Thus, a different L1 UL RS (reference signal) may be used to indicate that CG2 will be used by UE for UL transmission, in addition to using CG1. For example, to increase flexibility and reduce dependency on CG1, also due to that CG2 is common to all relevant UEs and there can be more than one CG2 instances per cell, each preconfigured CG2 instance which is commonly shared for all relevant UEs is coupled with (or associated with) a unique designated L1 UL RS common to all relevant UEs to indicate that CG2 will be used for UL transmission. In this case, a commonly shared resource (provided to all of these UEs that shared CG2) in time/frequency/code can be used by UEs to send the designated L1 UL reference signal (RS) or CG2-specific DMRS. By using a UL reference signal to indicate use of CG2, which may be used by multiple UEs, there is no need to allocate RS dedicated to individual UE and therefore no need to separate them by the serving gNB; and the common resource for sending such indication (indication that CG2 is used) can be provided even earlier than both CG1 and CG2 within/per Tp. The latter gives more time for the serving gNB to determine and make use of CG2 dynamically. However, to allow for proactive detection of collision on CG2 and allocation of resources for involved UEs to retransmit, using dedicated RS may be needed or at least useful.

With respect to the methods of FIGS. 2 and 5, in case one second configuration (e.g., CG2, FIG. 3) is configured to individual UE in association with a first configured grant (e.g., CG1, FIG. 3) per cell, the UE may be allocated with 2 DMRS (shared channel Demodulation Reference Signal), one DMRS sequence may be for CG1 and the other DMRS sequence may be provided for CG2, instead of having individual CG2 specific reference signals.

With respect to the methods of FIGS. 2 and 5, in case more than one CG2s (e.g., a set of CG2s)are configured to an individual UE in association with (or associated with) a CG1 (FIG. 3), UE may select at least one CG2 among the configured set of CG2s that best fit for the available amount of data to be transmitted within the current Tp. This gives further flexibility and efficiency in coping with highly variable packet size or data amount within/per Tp. In another option, user device (or UE) may select second configuration grants (e.g., CG2(s), FIG. 3), which will be used for UL transmission in addition to the associated first configuration grant (e.g., CG1, FIG. 3), which are closest to the first configured grant (CG1) in time for keeping the transmission latency as short as possible. Or as another example, the network node (e.g., BS or gNB) and the user device (e.g., UE) may agree on priority rules among all second configuration grants (e.g., among all CG2(s), FIG. 3).

With respect to the methods of FIGS. 2 and 5, various techniques may be used for packet duplication and/or coordination among cells or network nodes. Considering the current packet data convergence protocol (PDCP) duplication involving PCell and SCell, to make use of data correctly received on either CG1 or CG2 of SCell alone at PCell, the data division between CG1 and CG2 in PCell and SCell may need to be coordinated. For example, in the case where data division is due to a segmentation of a large packet, CG1 and CG2 configuration as well as the packet segmentation of PCell and SCell need to be in synch (synchronization) so that the first segment of the packet is sent on CG1 in PCell and its duplicate on CG2 in SCell whereas the second segment of the packet is sent on CG2 in PCell and its duplicate on CG1 in SCell, as an illustrative example embodiment. Then the data forwarding from the SCell to PCell may indicate whether the data is the received PDCP packet (received on both CG1 and CG2) or which segment of the packet the data is (received on either CG1 or CG2) so that PCell can make use of the data accordingly (macro diversity combining on either RLC/radio link control or PDCP). To facilitate this coordination between PCell and SCell along the configuration of the coupled CG1 and CG2 in PCell and SCell, either one of the following options may be applied: 1) In distributed coordination, when PCell and SCell are served by different gNBs, the serving gNB of PCell may indicate the serving gNB of SCell CG1 resources Ld allocated in PCell as well as Tp and MFBR via Xn interface using a XnAP procedure for Dual Connectivity. Based on the parameters, SCell can reserve resources for CG2 in SCell, (by Lm=Tp*MFBR when Lm=Ld+Ls). The PCell gNB informs UE on the CG1 resources and the SCell gNB on the CG2 resources. The UE indicates the both gNBs whether it uses CG2 and to which CG1 transmission the CG2 relates to. SCell gNB forwards the received packets to PCell gNB; or 2) In centralized coordination, when PCell and SCell are considered as 2 different carriers of the same serving gNB or PCell and SCell are provided by different DUs under control of the same CU (gNB centralized unit) of the serving gNB, the serving gNB may determine and configure the coupled CG1 and CG2 in a coordinated manner for both PCell and SCell. The PCell gNB informed UE of CG1 and CG2 resources. The UE indicates the both DUs (gNB distributed units) of the serving gNB whether it uses CG2 and to which CG1 transmission the CG2 relates to. SCell DU forwards the received packets to PCell DU in case the packet segmentation.

Examples 1-30 will be briefly described. Examples 1-30 may use or may be based on the configured grants (e.g., a first configured grant (CG1), and/or a second configured grant (CG2)) as shown in and described for FIG. 3. Also, the examples 1-30 may use or may be based on multi-connectivity as shown in and described for FIG. 4.

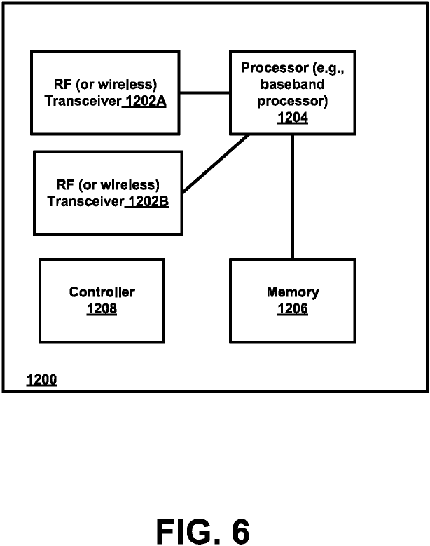

Example 1. An apparatus (e.g., 1200, FIG. 6) comprising: at least one processor (e.g., processor 1204, FIG. 6); and at least one memory (e.g., memory 1206, FIG. 6) including computer program code; the at least one memory and the computer program code configured to, with the at least one processor, cause the apparatus (e.g., apparatus in FIG. 6) at least to: receive (operation 210, FIG. 2), by a user device, a configuration associated with a first configured grant (e.g., CG1, FIG. 3) that is allocated to the user device and an indication of availability of resources associated with at least one second configured grant (CG2, FIG. 3) (e.g., a UE may receive a CG1 with dedicated resources, and may receive at least one CG2 with resources that may be shared by a plurality of UEs); and define (operation 220, FIG. 2), by the user device based on an amount of data to be transmitted, a latency requirement and/or a reliability requirement, that a transmission is to be performed by the user device using both the configuration associated with the first configured grant and at least part of the resources associated with the at least one second configured grant, and perform the transmission accordingly (e.g., for example, the UE 1200, FIG. 6, may determine that a data is to be transmitted via both CG1 and CG2, e.g., based on the UE determining that the amount of data to be transmitted by the UE exceeds a maximum data amount of the first configured grant; or determine, by the UE, that a reliability requirement of data to be transmitted by the user device exceeds a reliability performance that can be provided via use of only the first configured grant).

Example 2. The apparatus of example 1, wherein the at least one second configured grant (CG2, FIG. 3) is associated with the first configured grant (CG1, FIG. 3). For example, the second configured grant (e.g., CG2, FIG. 3) being associated with the first CG (e.g., CG1, FIG. 3) may mean or may include, for example, that the UE may transmit an amount of data via (e.g., via the total or cumulative resources of) both of the first configured grant (CG1, FIG. 3) and the associated second configured grant (CG2, FIG. 3). In some cases, certain conditions may be applied, at least in some example embodiments, that indicate the conditions under which the UE may be allowed to use the second configured grant (e.g., CG2, FIG. 3), in addition to the first configured grant (e.g., CG1, FIG. 3), e.g., so as to allow the data to be transmitted within the latency requirement, and/or to improve reliability or to meet a reliability requirement of the data. For example, a first portion of the data may be transmitted via CG1, and a second portion of the data may be transmitted via CG2. Or, data duplication may performed by the UE, e.g., by transmitting the data (or at least a portion of the data) via both CG1 and CG2 (e.g., this may include same data, or same or different redundancy versions being transmitted via CG1 and CG2), e.g., so as to improve reliability.

Example 3. The apparatus of any of examples 1-2, wherein being configured to cause the apparatus to define, based on an amount of data to be transmitted, a latency requirement and/or a reliability requirement, that a transmission is to be performed by the user device using both the configuration associated with the first configured grant and at least part of the resources associated with the at least one second configured grant, comprises being configured to cause the apparatus (e.g., apparatus 1200, FIG. 6) to perform at least one of the following: determine, by the user device, that the amount of data to be transmitted by the user device exceeds a maximum data amount of the first configured grant; or determine, by the user device, that a reliability requirement of data to be transmitted by the user device exceeds a reliability performance that can be provided via use of only the first configured grant. For example, if the maximum data amount of the first configured grant (e.g., CG1, FIG. 3) is less than the amount of data to be transmitted (within the latency period Tp), then the second configured grant (e.g., CG2, FIG. 3) may be used. Or, if the reliability offered or provided by transmission of the data via only the first configured grant (e.g., CG1, FIG. 3) does not meet the reliability requirements of the data or service flow, then the second configured grant (e.g., CG2, FIG. 3) may be used as well, e.g., where all or at least a portion of the data may be transmitted via both CG1 and CG2, in order to increase reliability of the data transmission.

Example 4. The apparatus of any of examples 1-3, wherein the first configured grant (e.g., CG1, FIG. 23 comprises a dedicated resource for the user device (e.g., a resource allocated for the UE) and wherein the at least one second configured grant (e.g., CG2, FIG. 3) comprises a shared resource available for a plurality of user devices for uplink transmission (e.g., where each of the plurality of UEs may use the CG2 to transmit data, e.g., at least under certain situations or conditions).

Example 5. The apparatus (e.g., 1200, FIG. 6) of any of examples 1-4, further being configured to cause the apparatus to: transmit, by the user device, an indication that the user device (e.g., UE) is transmitting data via the at least one second configured grant. See, e.g., 414 and/or 416, FIG. 4, where the UE 132 may send or transmit an indication (e.g., to a network node, such as to a SCell BS 410 and/or to PCell BS 412) that the UE is transmitting on the second configured grant (e.g., transmitting via the CG2, FIG. 3). This indication may allow the network node (e.g., BS or gNB) to receive data via both the first configured grant (e.g., CG1, FIG. 3) and the second configured grant (e.g., CG2, FIG. 3). If no indications is provided that a transmission is being performed on the second configured grant (CG2), the network node may, for example, reallocate resources of CG2 to another UE or for other purpose. Thus, for example, the UE may send an indication to a network node (e.g., BS, gNB, ...) to indicate that the UE is transmitting data via the second configured grant, which may indicate, that data is transmitted via both the first configured grant (CG1, FIG. 3) and the second configured grant (CG2, FIG. 3). In an illustrative example embodiment, a layer 1 or layer 2 signaling may be used by the UE to indicate that it is transmitting via the second configured grant (CG2), e.g., such as the UE transmitting a reference signal, such as by transmitting a demodulation reference signal (DMRS), that is, e.g., associated with (or specific to) the second configured grant, or indicates transmission by the UE via the second configured grant. Other signals may be used to indicate that the UE is transmitting via the second configured grant.

Example 6. The method of any of examples 1-5, wherein the at least one second configured grant (e.g., CG2, FIG. 3) indicates at least a shared resource that can be used, in addition to a dedicated resource of the first configured grant (e.g., CG1, FIG. 3), for uplink transmission by the user device if the amount of data to be transmitted by the user device within the latency requirement exceeds a maximum data amount of the first configured grant, or to improve a reliability of a data transmission by the user device by using both the first configured grant and the second configured grant. Thus, for example, a UE may transmit the data via both CG1 and CG2 if either the data amount to be transmitted within latency requirement (Tp) is greater than the maximum data amount of CG1 (and hence resources of CG2 may be used or required to allow transmission in parallel of portions of the data via CG1 and CG1). Or, in order to improve reliability of the data transmission, the UE may transmit all or at least a portion of the data via both the CG1 and CG2. Transmitting a same data or same portion of data, or redundancy versions of the data via CG1 and CG2 may improve the reliability of the data transmission, as compared to transmitting the data via just CG1.

Example 7. The apparatus of any of examples 1-6, wherein when the user device (e.g., UE 132, FIG. 4) is configured for multi-connectivity (e.g., UE 132 connected to both SCell BS 410, PCell BS 412) to allow the user device to transmit via both a primary cell (PCell) and a secondary cell (SCell), both the first configured grant (CG1) and the at least one second configured grant (CG2) are provided for the primary cell (e.g., CG1_p, CG2_p, FIG. 4), or both the first configured grant and the at least one second configured grant are provided for the secondary cell (e.g., CG1_s, CG2_s, FIG. 4), or the first configured grant is provided for the primary cell and the at least one second configured grant is provided for the secondary cell, or the first configured grant is provided for the secondary cell and the at least one second configured grant is provided for the primary cell.

Example 8. The apparatus of example 7 being further configured to cause the apparatus to use the multi-connectivity for data duplication of the uplink data transmission in which case a network node providing the primary cell and a network node providing the secondary cell coordinate the configuration of the first configured grant and the configuration of the at least one second configured grant. For example, the two network nodes that provide the primary cell and secondary cell of the multi-connectivity for the UE, may coordinate regarding what data will be transmitted over the CG1 and CG2 or the primary cell and secondary cell, e.g., see FIG. 4, where SCell BS 410 and PCell BS 412 may communicate and/or coordinate.

Example 9. An apparatus (e.g., 1200, FIG. 6), comprising: at least one processor (e.g., processor 1204, FIG. 6); and at least one memory (e.g., memory 1206, FIG. 6) including computer program code; the at least one memory and the computer program code configured to, with the at least one processor, cause the apparatus at least to: transmit (e.g., operation 510, FIG. 5), by a network node, a configuration associated with a first configured grant that is allocated to a user device and an indication of availability of resources associated with at least one second configured grant, wherein the at least one second configured grant is associated with the first configured grant (e.g., the network node or gNB may transmit a configuration of a first configured grant (e.g., CG1, FIG. 3), with a resource allocated to the UE, and the network node may communicate (e.g., broadcast or group-based signaling) a configuration of at least one second configured grant (e.g., CG2, FIG. 3) with shared resources); receive (e.g., operation 520, FIG. 5), by the network node, when the user device is transmitting via at least part of the resources associated with the at least one second configured grant, an indication that the user device is transmitting data according to the at least one second configured grant e.g., see operations 414 and/or 416, FIG. 4, where the UE 132 may send or transmit an indication (e.g., to a network node, such as to a SCell BS 410 and/or to PCell BS 412, FIG. 4) that the UE is transmitting on CG2, e.g., such as the UE transmitting a reference signal, such as by transmitting a demodulation reference signal (DMRS), that is, e.g., associated with (or specific to) the second configured grant, or indicates transmission by the UE via the second configured grant; receive (e.g., operation 530, FIG. 5), by the network node from the user device, as an uplink data transmission, data according to at least the first configured grant and, when indicated by the user device, also according to the at least one second configured grant (see, e.g., one or more of operations 420-426, as an illustrative example, where the network node (e.g., BS/gNB, such as nodes 410 and/or 412) may receive the data transmitted by the UE via resources of both CG1 and CG2); and when acting as a primary cell node (operation 540, FIG. 5), combine data related to the uplink data transmission (e.g., for example, the network node (e.g., gNB or BS), when acting as a PCell BS 412 (e.g., FIG. 4), may receive data from the UE, and may receive data forwarded by the SCell, and then may combine (macro-combining) both data); or when acting as a secondary cell node (operation 550, FIG. 5), transmit data related to the uplink data transmission to the primary cell node (e.g., when the network node (e.g., BS or gNB) is operating as a SCell BS 410 (FIG. 4), may forward received data to the PCell BS 412 (FIG. 4) for macro-combining).

Example 10. The apparatus of example 9 wherein the first configured grant (e.g., CG1, FIG. 3) comprises a dedicated resource for the user device (e.g., UL resources allocated to the UE) and wherein the at least one second configured grant (CG2, FIG. 3) comprises a shared resource available for a plurality of user devices for uplink transmission (e.g., an UL resource that may be use by any of the plurality of UEs for UL transmission, e.g., where a UE may use both (or may combine) resources of its allocated CG1 and the resources of the shared CG2, at least under certain conditions or situations.

Example 11. The apparatus of any of examples 9-10, wherein the at least one second configured grant (CG2, FIG. 2) comprises group-based scheduling of resources and/or dedicated scheduling of resources. For example, the network node may schedule CG2 or notify UEs of the CG2 via broadcast system information (e.g., transmitted system information block (SIB), or via transmission of a group-based transmission of a radio resource control (RRC) message). Also, an example of a dedicated scheduling of resources may include, for example, transmitting a configuration (e.g., CG configuration) or an indication of CG resources via dedicated transmission of a RRC message to the UE

Example 12. The apparatus of any of examples 9-11, wherein, when the user device is configured for multi-connectivity (e.g., see FIG. 3) to allow the user device (UE 132, or 1200 FIG. 6) to transmit via both a primary cell (PCell) and a secondary cell (SCell), wherein both the first configured grant (CG1, FIG. 3) and the at least one second configured grant (CG2, FIG. 3) are provided for the primary cell, or both the first configured grant and the at least one second configured grant are provided for the secondary cell, or the first configured grant is provided for the primary cell and the at least one second configured grant is provided for the secondary cell, or the first configured grant is provided for the secondary cell and the at least one second configured grant is provided for the primary cell. For example, different combinations of configured grants (CG1, CG2) may be provided for PCell and SCell. The CG1, CG2 may be provided for the PCell, the SCell, or a mix.

Example 13.The apparatus of example 12, further being configured to cause the apparatus to: coordinate reservation of resources for the first configured grant and the at least one second configured grant with the primary cell and the secondary cell for data duplication in association with the uplink data transmission using the multi-connectivity. For example, the UE 132 (FIG. 3) may be involved in requesting and/or coordinating the resources of CG1 and CG2 (FIG. 3), which may be used by the UE for data duplication, e.g., to increase reliability.

Example 14. The apparatus of example 13: wherein, when the coordinating reservation of resources is distributed, the primary cell node carries out configuration for the primary cell and the secondary cell node carries out configuration for the secondary cell (e.g., PCell BS 412 (FIG. 4) may coordinate or determine resources of primary cell, and SCell BS 410 (FIG. 4) may determine or coordinate resources of secondary cell); and wherein, when the coordinating reservation of resources is centralized, the primary cell node carries out configuration for both the primary cell and the secondary cell (e.g., in centralized resource coordination, PCell BS 412 (FIG. 4) may determine or coordinates resources for PCell and SCell, FIG. 4).

Example 15. FIG. 2 is a flow chart illustrating operation of a user device (UE) (e.g., UE 1200, FIG. 6) according to an example embodiment. Operation 210 includes receiving, by a user device (UE), a configuration associated with a first configured grant (e.g., CG1, FIG. 2) that is allocated to the user device and an indication of availability of resources associated with at least one second configured grant (e.g., CG2, FIG. 3 (e.g., the UE may receive a CG1 with dedicated resources, and may receive at least one CG2 with resources that may be shared by a plurality of UEs). For example, the UE may receive a first configured grant (e.g., CG1, FIG. 3) that includes a resource (e.g., time-frequency resources) that may be dedicated to the UE for uplink transmission. The UE may also receive a second configured grant (e.g., CG2, FIG. 3) (or, alternatively, at least one second configured grant). The second configured grant may include a dedicated or shared resource(s) (e.g., shared time-frequency resources that may be used by multiple UEs, including the UE, for uplink transmission.

Operation 220 of FIG. 2 includes defining, by the user device (e.g., UE) based on an amount of data to be transmitted, a latency requirement and/or a reliability requirement, that a transmission is to be performed by the user device using both the configuration associated with the first configured grant (e.g., CG1, FIG. 3) and at least part of the resources associated with the at least one second configured grant (e.g., at least a portion of the resources of CG2, FIG. 3), and performing the transmission accordingly. Thus, as an example, the UE may determine if the amount of data to be transmitted exceeds a maximum data amount of the first configured grant (CG1, FIG. 3). Thus, if the amount of data to be transmitted does not exceed the first configured grant (e.g., does not exceed the amount of data that can be transmitted via the first configured grant (CG1) within the latency requirement), then the amount of data may be transmitted by the UE via the first configured grant (e.g., and use of the second configured grant in such case is unnecessary to transmit the data within the latency requirement, since the data transmission within the latency requirement can be accommodated by the first configured grant). On the other hand, if the amount of data to be transmitted by the UE exceeds the maximum data amount of the first configured grant (e.g., CG1) (e.g., the amount of data to be transmitted within the latency requirement exceeds the maximum data amount of the first configured grant or which can be transmitted via the first configured grant within the latency requirement), then the UE is configured to use both the first configured grant and the second configured grant (e.g., both CG1, CG2, FIG. 3) to transmit the amount of data within the latency requirement (e.g., the UE transmits a first portion of the data via the first configured grant, and transmits a second portion of the data via the second configured grant, e.g., where the first configured grant and the second configured grant may have different time-frequency resources).

Also, with respect to operation 220 (FIG. 2), the at least one second configured grant (e.g., CG2, FIG. 2) can be used, in addition to a dedicated resource of the first configured grant (e.g., CG1, FIG. 3), for uplink transmission by the UE/user device if the (expected or estimated) reliability of the transmission of the data via only the first configured grant would not meet a reliability requirement of the data (or of the service flow associated with the data). In such case, the data (or amount of data) may be transmitted by the UE via both the first configured grant and via the second configured grant, e.g., in order to increase a reliability of the UE data transmission such that the transmission reliability (via use of both first and second configured grants) will (or is estimated to) meet or exceed the reliability requirement of the data or service flow. All or part of the data may be transmitted via both the first configured grant (e.g., CG1) and the second configured grant (CG2). For example, a duplicate of the data may be transmitted via both first configured grant (CG1) and second configured grant (CG2), or same or different redundancy versions of the data may be transmitted via first configured grant and second configured grant.

Also, for operation 220 of FIG. 3, for example, the UE 132 (FIG. 1, FIG. 4) may determine to use CG2 for a large packet or data amount in current Tp. In a multi-connectivity arrangement, for example, the UE 132 (FIG. 4) may determine to use the second CGs (CG2_p and CG2_s) (e.g., in addition to CG1_p and CG1_s) for a large packet, or an amount of data in a current Tp. For example, the UE 132 may determine that an amount of data to be transmitted exceeds a maximum data amount of CG1_p or CG1_s, and thus, may need to also use CG2_p and CG2_s (e.g., see FIG. 4) to transmit the amount of data within Tp.

Example 16. The method of example 15, wherein the at least one second configured grant is associated with the first configured grant. For example, the second CG (CG2, FIG. 3) being associated with the first CG (CG1, FIG. 3) may mean or may include, for example, that the UE may transmit an amount of data via (e.g., via the total or cumulative resources of) both of the first configured grant (CG1, FIG. 3) and the associated second configured grant (CG2, FIG. 3). In some cases, certain conditions may be applied, at least in some example embodiments, that indicate the conditions under which the UE may be allowed to use the CG2 (in addition to CG1), e.g., so as to allow the data to be transmitted within the latency requirement, and/or to improve reliability or to meet a reliability requirement of the data. For example, a first portion of the data may be transmitted via CG1, and a second portion of the data may be transmitted via CG2. Or, data duplication may performed by the UE, e.g., by transmitting the data (or at least a portion of the data) via both CG1 and CG2 (e.g., this may include same data, or same or different redundancy versions being transmitted via CG1 and CG2).

Example 17. The method of any of examples 15-16, wherein the defining comprises performing at least one of the following: determining, by the user device, that the amount of data to be transmitted by the user device exceeds a maximum data amount of the first configured grant; or determining, by the user device, that a reliability requirement of data to be transmitted by the user device exceeds a reliability performance that can be provided via use of only the first configured grant. Thus, as an example, the UE may determine if the amount of data to be transmitted exceeds a maximum data amount of the first configured grant (CG1, FIG. 3). Thus, if the amount of data to be transmitted does not exceed the first configured grant (e.g., does not exceed the amount of data that can be transmitted via the first configured grant (CG1) within the latency requirement), then the amount of data may be transmitted by the UE via the first configured grant (e.g., and use of the second configured grant in such case is unnecessary to transmit the data within the latency requirement, since the data transmission within the latency requirement can be accommodated by the first configured grant). On the other hand, if the amount of data to be transmitted by the UE exceeds the maximum data amount of the first configured grant (e.g., CG1) (e.g., the amount of data to be transmitted within the latency requirement exceeds the maximum data amount of the first configured grant or which can be transmitted via the first configured grant within the latency requirement), then the UE is configured to use both the first configured grant and the second configured grant (e.g., both CG1, CG2, FIG. 3) to transmit the amount of data within the latency requirement (e.g., the UE transmits a first portion of the data via the first configured grant, and transmits a second portion of the data via the second configured grant, e.g., where the first configured grant and the second configured grant may have different time-frequency resources). Also, the defining or determining may include if the (expected or estimated) reliability of the transmission of the data via only the first configured grant would not meet a reliability requirement of the data (or of the service flow associated with the data). Thus, the defining or determining may include determining that the at least one second configured grant (e.g., CG2, FIG. 2) can be used, in addition to a dedicated resource of the first configured grant (e.g., CG1, FIG. 3), for uplink transmission by the UE/user device if the (expected or estimated) reliability of the transmission of the data via only the first configured grant would not meet a reliability requirement of the data (or of the service flow associated with the data). In such case, the data (or amount of data) may be transmitted by the UE via both the first configured grant and via the second configured grant, e.g., in order to increase a reliability of the UE data transmission such that the transmission reliability (via use of both first and second configured grants) will (or is estimated to) meet or exceed the reliability requirement of the data or service flow. All or part of the data may be transmitted via both the first configured grant (e.g., CG1) and the second configured grant (CG2).

Example 18. The method of any of examples 15-17, wherein the first configured grant (e.g. CG1, FIG. 3) comprises a dedicated resource for the user device (e.g., a resource allocated or granted to the UE for UL transmission) and wherein the at least one second configured grant (e.g., CG2, FIG. 3) comprises a shared resource available for a plurality of user devices for uplink transmission (e.g., where each of the plurality of UEs may use the CG2 to transmit data, e.g., at least under certain situations or conditions).

Example 19. The method of any of examples 15-18, further comprising: transmitting, by the user device, an indication that the user device is transmitting data via the at least one second configured grant. Also, see operations 414 and/or 416, FIG. 4, where the UE 132 may send or transmit an indication (e.g., to a network node, such as to a SCell BS 410 and/or to PCell BS 412) that the UE is transmitting on CG2. This indication may allow the network node to receive data via both CG1 and CG2 (e.g., since, based on this indication, the network node has now been informed that data will also be transmitted by the UE, and thus, likely received by the network node, via resources of CG2, in addition to resources of CG1). If no indication is provided that a transmission is being performed on CG2, the network node may, for example, reallocate resources of CG2 to another UE or for other purpose. Thus, for example, the UE may send an indication to a network node (e.g., BS, gNB, ...) to indicate that the UE is transmitting data via the second configured grant, which may indicate, that data is transmitted via both the first configured grant (CG1, FIG. 3) and the second configured grant (CG2, FIG. 3). In an illustrative example embodiment, a layer 1 or layer 2 signaling may be used by the UE to indicate that it is transmitting via the second configured grant (CG2), e.g., such as the UE transmitting a reference signal, such as by transmitting a demodulation reference signal (DMRS), that is, e.g., associated with (or specific to) the second configured grant (associated with CG2), or indicates transmission by the UE via the second configured grant (CG2, FIG. 2). Other signals may be used to indicate that the UE is transmitting via the second configured grant (CG2, FIG. 3).

Example 20. The method of any of examples 15-19, wherein the at least one second configured grant indicates at least a shared resource that can be used, in addition to a dedicated resource of the first configured grant, for uplink transmission by the user device if the amount of data to be transmitted by the user device within the latency requirement exceeds a maximum data amount of the first configured grant, or to improve reliability of a data transmission by the user device by using both the first configured grant and the second configured grant. Thus, for example, a UE may transmit the data via both CG1 and CG2 (e.g., see FIG. 3) if either the data amount to be transmitted within latency requirement (Tp) is greater than the maximum data amount of CG1 (and hence resources of CG2 may be used or required to allow transmission in parallel of portions of the data via CG1 and CG1). Or, in order to improve reliability of the data transmission, the UE may transmit all or at least a portion of the data via both the CG1 and CG2. Transmitting a same data or same portion of data, or redundancy versions of the data via CG1 and CG2 may improve the reliability of the data transmission, as compared to transmitting the data via just CG1. The at least one second configured grant (e.g., CG2, FIG. 3) can be used, in addition to a dedicated resource of the first configured grant (e.g., CG1, FIG. 3), for uplink transmission by the UE/user device if the (expected or estimated) reliability of the transmission of the data via only the first configured grant would not meet a reliability requirement of the data (or of the service flow associated with the data). In such case, the data (or amount of data) may be transmitted by the UE via both the first configured grant and via the second configured grant, e.g., in order to increase a reliability of the UE data transmission such that the transmission reliability (via use of both first and second configured grants) will (or is estimated to) meet or exceed the reliability requirement of the data or service flow.

Example 21. The method of any of examples 15-20, wherein when the user device (e.g., UE 132, FIGS. 1, 4) is configured for multi-connectivity to allow the user device (UE 132, FIG. 4) to transmit via both a primary cell (PCell, FIG. 4) and a secondary cell (SCell, FIG. 34 both the first configured grant (CG1, FIG. 2) and the at least one second configured grant (CG2, FIG. 3) are provided for the primary cell (e.g., CG1_p, CG2_p, FIG. 4), or both the first configured grant and the at least one second configured grant are provided for the secondary cell (e,g., CG1_s, CG2_s, FIG. 4), or the first configured grant (CG1) is provided for the primary cell (CG1_p) and the at least one second configured grant (CG2) is provided for the secondary cell (CG2_s), or the first configured grant (CG1) is provided for the at least one secondary cell (CG1_s) and the second configured grant (CG2) is provided for the primary cell (CG2_p).

Example 22. The method of example 21, further comprising using the multi-connectivity for data duplication of the uplink data transmission in which case a network node providing the primary cell and a network node providing the secondary cell coordinate the configuration of the first configured grant and the configuration of the at least one second configured grant. For example, the two network nodes (e.g., PCell BS 412, SCell BS 410, FIG. 4) that provide the primary cell and secondary cell of the multi-connectivity for the UE, may coordinate regarding what data will be transmitted over the CG1 and CG2 or the primary cell and secondary cell, e.g., see FIG. 3, where SCell BS 410 and PCell BS 412 may communicate and/or coordinate.

Example 23. FIG. 5 is a flow chart illustrating operation of a network node according to an example embodiment. Operation 510 includes transmitting, by a network node (e.g., BS or gNB), a configuration associated with a first configured grant (e.g., CG1, FIG. 3) that is allocated to a user device (e.g., UE 131, FIGS. 1, 4) and an indication of availability of resources associated with at least one second configured grant (e.g., CG2, FIG. 3), wherein the at least one second configured grant is associated with the first configured grant. For example, the network node or gNB may transmit a configuration of a CG1, with a resource allocated to the UE, and the network node may communicate (e.g., broadcast or group-based signaling) a configuration of at least one CG2, with shared resources. For example, CG1 and CG2 can be configured by the serving cell or dual/multi connectivity may be applied and both or either of the CG1 and CG2 may be configured by a secondary cell. However, CG1 and CG2 may be different for a primary cell (PCell) and a secondary cell (SCell), though. The cell may be indicated by cell ID. In the case of packet duplication, the first transmissions may be carried out in the primary cell and the duplicate transmissions in the secondary cell, and vice versa for example. The network node or BS may send to UE a first configured grant (e.g., CG1, FIG. 3) that includes a resource (e.g., time-frequency resources) that may be dedicated to the UE for uplink transmission, and a second configured grant (e.g., CG2, FIG. 3) (or, alternatively, at least one second configured grant). The second configured grant (CG2) may include a dedicated or shared resource(s), e.g., shared time-frequency resources that may be used by multiple UEs, including the UE, for uplink transmission. Also, for example, the second CG (CG2, FIG. 3) being associated with the first CG (CG1, FIG. 3) may mean or may include, for example, that the UE may transmit an amount of data via (e.g., via the total or cumulative resources of) both of the first configured grant (CG1, FIG. 3) and the associated second configured grant (CG2, FIG. 3). In some cases, certain conditions may be applied, at least in some example embodiments, that indicate the conditions under which the UE may be allowed to use the CG2 (in addition to CG1), e.g., so as to allow the data to be transmitted within the latency requirement, and/or to improve reliability or to meet a reliability requirement of the data. For example, a first portion of the data may be transmitted via CG1, and a second portion of the data may be transmitted via CG2. Or, data duplication may performed by the UE, e.g., by transmitting the data (or at least a portion of the data) via both CG1 and CG2 (e.g., this may include same data, or same or different redundancy versions being transmitted via CG1 and CG2).

Operation 520 of FIG. 5 includes receiving, by the network node, when the user device is transmitting via at least part of the resources associated with the second configured grant (CG2), an indication that the user device is transmitting data according to the second configured grant. See, e.g., operations 414 and/or 416, FIG. 4, where the UE 132 may send or transmit an indication (e.g., to a network node, such as to a SCell BS 410 and/or to PCell BS 412) that the UE is transmitting on CG2. This indication may be received by the network node, and may allow the network node to receive data via both CG1 and CG2. If no indications is provided that a transmission is being performed on CG2, the network node may, for example, reallocate resources of CG2 to another UE or for other purpose. Thus, for example, the UE may send an indication to a network node (e.g., BS, gNB, ...) to indicate that the UE is transmitting data via the second configured grant, which may indicate, that data is transmitted via both the first configured grant (CG1, FIG. 3) and the second configured grant (CG2, FIG. 3). In an illustrative example embodiment, a layer 1 or layer 2 signaling may be used by the UE to indicate that it is transmitting via the second configured grant (CG2, FIG. 3), e.g., such as the UE transmitting a reference signal, such as by transmitting a demodulation reference signal (DMRS), that is, e.g., associated with (or specific to) the second configured grant, or indicates transmission by the UE via the second configured grant. Other signals may be used to indicate that the UE is transmitting via the second configured grant.

Operation 530 of FIG. 5 includes receiving, by the network node from the user device, as an uplink data transmission, data according to at least the first configured grant (CG1, FIG. 3) and, when indicated by the user device, also according to the second configured grant (CG2, FIG. 3). See, e.g., one or more of operations 420 - 426 (FIG. 4), as an illustrative example, where the UE may transmit the data via resources of both CG1 and CG2.

Operation 540 of FIG. 5 includes when acting as a primary cell node, combining data related to the uplink data transmission. For example, the network node (e.g., gNB), when acting as a PCell BS 412 (FIG. 4), may receive data from the UE, and may receive data forwarded by the SCell, and then may combine (macro-combining) both data.

And, operation 550 of FIG. 5 includes: Or, when acting as a secondary cell node, transmitting data related to the uplink data transmission to the primary cell node. For example, when the network node is operating as a SCell BS 410 (FIG. 4), may forward received data to the PCell BS 412 for macro-combining. Thus, the network node may operate as either a primary cell (PCell) node, or a secondary cell (SCell) node.

Example 24. The method of example 23, wherein the first configured grant (CG1, FIG. 3) comprises a dedicated resource (e.g., a resource for UL transmission allocated to the UE) for the user device/UE and wherein the at least one second configured grant (e.g., CG2, FIG. 3) comprises a shared resource (e.g., a resource for UL transmission made available to a plurality of UEs, at least under certain conditions) available for a plurality of user devices/UEs for uplink transmission.

Example 25. The method of any of examples 23-24, wherein, when the user device (UE) is configured for multi-connectivity (e.g., see FIG. 4) to allow the user device (UE 132, FIGS. 1, 4) to transmit via both a primary cell (PCell) and a secondary cell (SCell), both the first configured grant (CG1, FIG. 3) and the at least one second configured grant (CG2, FIG. 3) are provided for the primary cell, or both the first configured grant and the at least one second configured grant are provided for the secondary cell, or the first configured grant is provided for the primary cell and the at least one second configured grant is provided for the at least one secondary cell, or the first configured grant is provided for the secondary cell and the at least one second configured grant is provided for the primary cell. For example, different combinations of configured grants (CG1, CG2) may be provided for PCell and SCell. The CG1, CG2 may be provided for the PCell, the SCell, or a mix.

Example 26. The method of example 25, further comprising: coordinating (e.g., by the network node, or gNB) reservation of resources for the first configured grant (CG1, FIG. 3) and the at least one second configured grant (CG2, FIG. 3) with the primary cell and the secondary cell for data duplication in association with the uplink data transmission. For example, PCell BS 412 (FIG. 4) may coordinate or determine resources of primary cell and secondary cell, or PCell BS 412 (FIG. 4) may determine or coordinate only CG resources of the PCell, and SCell BS 410 may determine or coordinate CG resources of the SCell. The PCell BS 412 and the SCell BS 410 may communicate to establish these resources and/or determine what data will be transmitted over specific CG resources of specific cells.

Example 27. The method of example 26: wherein, when the coordinating reservation of resources is distributed, the primary cell node carries out configuration for the primary cell and the secondary cell node carries out configuration for the secondary cell; and wherein, when the coordinating reservation of resources is centralized, the primary cell node carries out configuration for both the primary cell and the secondary cell. For example, PCell BS 412 (FIG. 4) may coordinate or determine resources of primary cell and secondary cell (centralized), or PCell BS 412 may determine or coordinate only CG resources of the PCell, and SCell BS 410 may determine or coordinate CG resources of the SCell (distributed). The PCell BS 412 and the SCell BS 410 may communicate to establish these resources and/or determine what data will be transmitted over specific CG resources of specific cells.

Example 28. An apparatus (e.g., see apparatus 1200, FIG. 6) comprising means for performing the method of any of examples 15-27. It should be appreciated that the apparatus may include or otherwise be in communication with a control unit, one or more processors or other entities capable of carrying out operations according to the embodiments described by means of FIG. 2 or FIG. 5. It should be understood, that each block of the flowchart of FIG. 2 or FIG. 5 and any combination thereof may be implemented by various means or their combinations, such as hardware, software, firmware, one or more processors and/or (electronic) circuitry.

As used in this application, the term ‘circuitry’ (or circuit) refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An apparatus (a user device, FIG. 2) may comprise means (1202A, 1202B, 1204, 1206 depending on implementation) for receiving, by a user device, a configuration associated with a first configured grant that is allocated to the user device and an indication of availability of resources associated with at least one second configured grant; and means (1204, 1206) for defining, by the user device based on an amount of data to be transmitted, a latency requirement and/or a reliability requirement, that a transmission is to be performed by the user device using both the configuration associated with the first configured grant and at least part of the resources associated with the at least one second configured grant, and means (1202A, 1202B, 1204, 1206 depending on the implementation) for performing the transmission accordingly.

An apparatus, (gNB, access node, or distributed unit (DU), FIG. 5) may comprise means (1202A, 1202B, 1204, 1206) depending on the implementation) for transmitting, by a network node, a configuration associated with a first configured grant that is allocated to a user device and an indication of availability of resources associated with at least one second configured grant, wherein the at least one second configured grant is associated with the first configured grant, means (1202A, 1202B, 1204, 1206) for receiving, by the network node, when the user device is transmitting via at least part of the resources associated with the second configured grant, an indication that the user device is transmitting data according to the second configured grant, means (1202A, 1202B, 1204, 1206) receiving, by the network node from the user device, as an uplink data transmission, data according to at least the first configured grant and, when indicated by the user device, also according to the second configured grant, and when acting as a primary cell node, means (1204, 1206) for combining data related to the uplink data transmission, or when acting as a secondary cell node, means (1204, 1206) for transmitting data related to the uplink data transmission to the primary cell node.

It should be appreciated utilizing network functions virtualization (NFV), a network architecture concept that proposes virtualizing network node functions into “building blocks” or entities that may be operationally connected or linked together to provide services, is also an option. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts.

Example 29. A computer program comprising instructions which, when the program is executed by a computer, cause the computer to carry out the method of any of examples 15-27 (see FIG. 2 or FIG. 5). Terms “receive”, “transmit” and “broadcast” may comprise reception or transmission via a radio path. These terms may also mean preparation of a message to the radio path for an actual transmission or processing a message received from the radio path, for example, or controlling or causing a transmission or reception, when embodiments are implemented by software.

Programs, also called program products or computer programs, including software routines, applets and macros, may be stored in any apparatus-readable data storage medium and they include program instructions to perform particular tasks. The data storage medium may be a non-transitory medium. The computer program or computer program product may also be downloaded to the apparatus. A computer program product may comprise one or more computer-executable components which, when the program is run, for example by one or more processors possibly also utilizing an internal or external memory, are configured to carry out any of the embodiments or combinations thereof described above by means of FIG. 2 or FIG. 5. The one or more computer-executable components may be at least one software code or portions thereof. Computer programs may be coded by a (high level) programming language or a low-level programming language.

Example 30. An apparatus comprising: at least one processor (e.g., processor 1204, FIG. 6); and at least one memory (e.g., memory 1206, FIG. 6) including computer program code; the at least one memory and the computer program code configured to, with the at least one processor, cause the apparatus at least to perform the method of any of examples 15-27.

FIG. 6 is a block diagram of a wireless station (e.g., AP, BS or user device/UE, or another network node) 1200 according to an example embodiment. The wireless station 1200 may include, for example, one or more (e.g., two as shown in FIG. 6) RF (radio frequency) or wireless transceivers 1202A, 1202B, where each wireless transceiver includes a transmitter to transmit signals and a receiver to receive signals. The wireless station also includes a processor or control unit/entity (controller) 1204 to execute instructions or software and control transmission and receptions of signals, and a memory 1206 to store data and/or instructions.

Processor 1204 may also make decisions or determinations, generate frames, packets or messages for transmission, decode received frames or messages for further processing, and other tasks or functions described herein. Processor 1204, which may be a baseband processor, for example, may generate messages, packets, frames or other signals for transmission via wireless transceiver 1202 (1202A or 1202B). Processor 1204 may control transmission of signals or messages over a wireless network, and may control the reception of signals or messages, etc., via a wireless network (e.g., after being down-converted by wireless transceiver 1202, for example). Processor 1204 may be programmable and capable of executing software or other instructions stored in memory or on other computer media to perform the various tasks and functions described above, such as one or more of the tasks or methods described above. Processor 1204 may be (or may include), for example, hardware, programmable logic, a programmable processor that executes software or firmware, and/or any combination of these. Using other terminology, processor 1204 and transceiver 1202 together may be considered as a wireless transmitter/receiver system, for example.

In addition, referring to FIG. 6, a controller (or processor) 1208 may execute software and instructions, and may provide overall control for the station 1200, and may provide control for other systems not shown in FIG. 6, such as controlling input/output devices (e.g., display, keypad), and/or may execute software for one or more applications that may be provided on wireless station 1200, such as, for example, an email program, audio/video applications, a word processor, a Voice over IP application, or other application or software.

In addition, a storage medium may be provided that includes stored instructions, which when executed by a controller or processor may result in the processor 1204, or other controller or processor, performing one or more of the functions or tasks described above.

According to another example embodiment, RF or wireless transceiver(s) 1202A/1202B may receive signals or data and/or transmit or send signals or data. Processor 1204 (and possibly transceivers 1202A/1202B) may control the RF or wireless transceiver 1202A or 1202B to receive, send, broadcast or transmit signals or data.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, ...) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. An apparatus comprising:
at least one processor; and
at least one memory including computer program code;
the at least one memory and the computer program code configured to, with the at least one processor, cause the apparatus at least to:
receive, by a user device, a configuration associated with a first configured grant that is allocated to the user device and an indication of availability of resources associated with at least one second configured grant; and
define, by the user device based on an amount of data to be transmitted, a latency requirement and/or a reliability requirement, that a transmission is to be performed by the user device using both the configuration associated with the first configured grant and at least part of the resources associated with the at least one second configured grant, and perform the transmission accordingly.

2. The apparatus of claim 1, wherein the at least one second configured grant is associated with the first configured grant.

3. The apparatus of claim 1, wherein being configured to cause the apparatus to define, based on an amount of data to be transmitted, a latency requirement and/or a reliability requirement, that a transmission is to be performed by the user device using both the configuration associated with the first configured grant and at least part of the resources associated with the at least one second configured grant,, comprises being configured to cause the apparatus to perform at least one of the following:
determine, by the user device, that the amount of data to be transmitted by the user device exceeds a maximum data amount of the first configured grant; or
determine, by the user device, that a reliability requirement of data to be transmitted by the user device exceeds a reliability performance that can be provided via use of only the first configured grant.

4. The apparatus of claim 1, wherein the first configured grant comprises a dedicated resource for the user device and wherein the at least one second configured grant comprises a shared resource available for a plurality of user devices for uplink transmission.

5. The apparatus of claim 1, further being configured to cause the apparatus to:
transmit, by the user device, an indication that the user device is transmitting data via the at least one second configured grant.

6. The apparatus of claim 1, wherein the at least one second configured grant indicates at least a shared resource that can be used, in addition to a dedicated resource of the first configured grant, for uplink transmission by the user device if the amount of data to be transmitted by the user device within the latency requirement exceeds a maximum data amount of the first configured grant, or to improve a reliability of a data transmission by the user device by using both the first configured grant and the second configured grant.

7. The apparatus of claim 1, wherein when the user device is configured for multi-connectivity to allow the user device to transmit via both a primary cell and a secondary cell, both the first configured grant and the at least one second configured grant are provided for the primary cell, or both the first configured grant and the at least one second configured grant are provided for the secondary cell, or the first configured grant is provided for the primary cell and the at least one second configured grant is provided for the secondary cell, or the first configured grant is provided for the secondary cell and the at least one second configured grant is provided for the primary cell.

8. (canceled)

9. An apparatus, comprising:
at least one processor; and
at least one memory including computer program code;
the at least one memory and the computer program code configured to, with the at least one processor, cause the apparatus at least to:
transmit, by a network node, a configuration associated with a first configured grant that is allocated to a user device and an indication of availability of resources associated with at least one second configured grant, wherein the at least one second configured grant is associated with the first configured grant;
receive, by the network node, when the user device is transmitting via at least part of the resources associated with the at least one second configured grant, an indication that the user device is transmitting data according to the at least one second configured grant;
receive, by the network node from the user device, as an uplink data transmission, data according to at least the first configured grant and, when indicated by the user device, also according to the at least one second configured grant; and
when acting as a primary cell node, combine data related to the uplink data transmission; or
when acting as a secondary cell node, transmit data related to the uplink data transmission to the primary cell node.

10. The apparatus of claim 9 wherein the first configured grant comprises a dedicated resource for the user device and wherein the at least one second configured grant comprises a shared resource available for a plurality of user devices for uplink transmission.

11. The apparatus of claim 9, wherein the first configured grant comprises a dedicated resource for the user device and wherein the at least one second configured grant comprises a shared resource available for a plurality of user devices for uplink transmission, and wherein the at least one second configured grant comprises group-based scheduling of resources and/or dedicated scheduling of resources.

12. The apparatus of claim 9, wherein, when the user device is configured for multi-connectivity to allow the user device to transmit via both a primary cell and a secondary cell, wherein both the first configured grant and the at least one second configured grant are provided for the primary cell, or both the first configured grant and the at least one second configured grant are provided for the secondary cell, or the first configured grant is provided for the primary cell and the at least one second configured grant is provided for the secondary cell, or the first configured grant is provided for the secondary cell and the at least one second configured grant is provided for the primary cell.

13-14. (canceled)

15. A method comprising:
receiving, by a user device, a configuration associated with a first configured grant that is allocated to the user device and an indication of availability of resources associated with at least one second configured grant; and
defining, by the user device based on an amount of data to be transmitted, a latency requirement and/or a reliability requirement, that a transmission is to be performed by the user device using both the configuration associated with the first configured grant and at least part of the resources associated with the at least one second configured grant, and performing the transmission accordingly.

16. The method of claim 15, wherein the at least one second configured grant is associated with the first configured grant.

17. The method of claim 15, wherein the defining comprises performing at least one of the following:
determining, by the user device, that the amount of data to be transmitted by the user device exceeds a maximum data amount of the first configured grant; or determining, by the user device, that a reliability requirement of data to be transmitted by the user device exceeds a reliability performance that can be provided via use of only the first configured grant.

18. The method of claim 15, wherein the first configured grant comprises a dedicated resource for the user device and wherein the at least one second configured grant comprises a shared resource available for a plurality of user devices for uplink transmission.

19. The method of claim 15, further comprising: transmitting, by the user device, an indication that the user device is transmitting data via the at least one second configured grant.

20. The method of claim 15, wherein the at least one second configured grant indicates at least a shared resource that can be used, in addition to a dedicated resource of the first configured grant, for uplink transmission by the user device if the amount of data to be transmitted by the user device within the latency requirement exceeds a maximum data amount of the first configured grant, or to improve reliability of a data transmission by the user device by using both the first configured grant and the second configured grant.

21. The method of claim 15, wherein when the user device is configured for multi-connectivity to allow the user device to transmit via both a primary cell and a secondary cell, both the first configured grant and the at least one second configured grant are provided for the primary cell, or both the first configured grant and the at least one second configured grant are provided for the secondary cell, or the first configured grant is provided for the primary cell and the at least one second configured grant is provided for the secondary cell, or the first configured grant is provided for the at least one secondary cell and the second configured grant is provided for the primary cell.

22. (canceled)

23. A method comprising:
transmitting, by a network node, a configuration associated with a first configured grant that is allocated to a user device and an indication of availability of resources associated with at least one second configured grant, wherein the at least one second configured grant is associated with the first configured grant;
receiving, by the network node, when the user device is transmitting via at least part of the resources associated with the second configured grant, an indication that the user device is transmitting data according to the second configured grant;
receiving, by the network node from the user device, as an uplink data transmission, data according to at least the first configured grant and, when indicated by the user device, also according to the second configured grant; and
when acting as a primary cell node, combining data related to the uplink data transmission; or
when acting as a secondary cell node, transmitting data related to the uplink data transmission to the primary cell node.

24. The method of claim 23, wherein the first configured grant comprises a dedicated resource for the user device and wherein the at least one second configured grant comprises a shared resource available for a plurality of user devices for uplink transmission.

25. The method of claim 23, wherein, when the user device is configured for multi-connectivity to allow the user device to transmit via both a primary cell and a secondary cell, both the first configured grant and the at least one second configured grant are provided for the primary cell, or both the first configured grant and the at least one second configured grant are provided for the secondary cell, or the first configured grant is provided for the primary cell and the at least one second configured grant is provided for the at least one secondary cell, or the first configured grant is provided for the secondary cell and the at least one second configured grant is provided for the primary cell.

26-29. (canceled)
